(19) United States
(12) Patent Application Publication
(10) Pub. No.: US 2026/0251002 A1
(43) Pub. Date: Aug. 27, 2026

(54) REFRIGERATOR AND METHOD FOR CONTROLLING THE SAME

(71) Applicant: SAMSUNG ELECTRONICS CO., LTD., Suwon-si (KR)

(72) Inventors: Jihyun RYU, Suwon-si (KR); Jongsoo HONG, Suwon-si (KR); Taegyoon NOH, Suwon-si (KR); Chunseong KIM, Suwon-si (KR); Yongchan KWON, Suwon-si (KR)

(73) Assignee: SAMSUNG ELECTRONICS CO., LTD., Suwon-si (KR)

(21) Appl. No.: 19/537,763

(22) Filed: Feb. 12, 2026

Related U.S. Application Data
(63) Continuation of application No. PCT/KR2026/001889, filed on Feb. 2, 2026.

(30) Foreign Application Priority Data
Feb. 27, 2025 (KR) 10-2025-0026240

(51) Int. Cl. E05F 15/41; E05F 15/79; F25D 23/02

(52) U.S. Cl. CPC E05F 15/41; E05F 15/79; F25D 23/028; E05Y 2400/814; E05Y 2900/31

(57) ABSTRACT

A refrigerator includes a main body including a storage compartment, a door configured to rotate to open or close the storage compartment, a door driving device configured to open or close the door, a communication interface configured to communicate with an external device, and a controller configured to receive setting information from the external device through the communication interface, the setting information including at least one received setting information item among setting information items to set a door opening speed, a door closing speed, an opening time delay from a time point at which an opening condition is satisfied, or a closing time delay from a time point at which a closing condition is satisfied, and control the door driving device such that the door is opened or closed, based on the opening or closing condition being satisfied, and according to the at least one received setting information item.

### CROSS-REFERENCE TO RELATED APPLICATIONS

This application is a continuation application, under 35 U.S.C. §111(a), of International Application No. PCT/KR2026/001889, filed on February 2, 2026, which claims priority under 35 U.S.C. §119 to Korean Patent Application No. 10-2025-0026240, filed on February 27, 2025, in the Ministry of Intellectual Property, the disclosures of which are incorporated by reference herein in their entirety.

### DESCRIPTION

### TECHNICAL FIELD

The disclosure relates to a refrigerator capable of automatically opening and closing a refrigerator door, and a method for controlling the refrigerator.

### BACKGROUND ART

A refrigerator is an appliance that includes a main body with a storage compartment, and a cold air supply system for supplying cold air to the storage compartment so as to keep food fresh. The storage compartment may include a refrigerating compartment maintained at approximately 0 to 5 ℃ to store food in a refrigerated manner, and a freezing compartment maintained at approximately 0 to -30 ℃ to store food in a frozen manner. The storage compartment is designed with an open front to put food in and out.

The refrigerator includes a door that opens and closes the storage compartment. The door is rotatable with respect to the main body to open and close the storage compartment.

A user is able to open and close the door by gripping a handle on the door and rotating the door with respect to the main body.

Recently, to improve user experience, an auto door function has been introduced that automatically opens and closes the door, without the user having to directly open and close the door.

The refrigerator with the auto door function includes a touch sensor provided on the front surface of the door for automatically opening and closing the door. As a result, to automatically open or close the door, the user requires to move to the front of the door and operate the touch sensor, causing user inconvenience.

### Disclosure

### Technical Problem

According to the disclosure, a refrigerator and a method for controlling the same may remotely control an auto door function, implement various auto door functions, and monitor an operating state of a door in real time using a smart appliance application.

According to the disclosure, a refrigerator and a method for controlling the same may adjust an opening speed and a closing speed of a door using a smart appliance application.

According to the disclosure, a refrigerator and a method for controlling the same may adjust a door opening delay and a door closing delay using a smart appliance application.

According to the disclosure, a refrigerator and a method for controlling the same may adjust a door alarm volume using a smart appliance application.

According to the disclosure, a refrigerator and a method for controlling the same may detect an abnormal operation of a door when automatically opening or closing the door using a smart appliance application and notify a user of the abnormal operation through the smart appliance application.

Technical aspects that can be achieved by the disclosure are not limited to the above-mentioned aspects, and other technical aspects not mentioned will be clearly understood by one of ordinary skill in the technical art to which the disclosure belongs from the following description.

### Technical Solution

According to an embodiment of the disclosure, a refrigerator may include a main body including a storage compartment, a door configured to rotate to open or close the storage compartment, a door driving device configured to open or close the door, a communication interface configured to communicate with an external device, and a controller configured to receive setting information from the external device through the communication interface, the setting information including at least one received setting information item among setting information items to set an opening speed of the door, a closing speed of the door, an opening time delay of the door from a time point at which an opening condition is satisfied, or a closing time delay of the door from a time point at which a closing condition is satisfied, and control the door driving device such that the door is opened or closed, based on the opening condition or the closing condition being satisfied, and according to the at least one received setting information item among the setting information items.

According to an embodiment of the disclosure, a method of controlling a refrigerator may include executing by a controller of the refrigerator a process configured by the controller that includes receiving setting information including at least one received setting information item among setting information items to set an opening speed of a door of the refrigerator, a closing speed of the door, an opening time delay of the door from a time point at which an opening condition is satisfied, or a closing time delay of the door from a time point at which a closing condition is satisfied, and opening or closing the door, based on the opening condition or the closing condition being satisfied, and according to the at least one received setting information item among the setting information items.

### DESCRIPTION OF DRAWINGS

FIG. 1 is a front view illustrating a state in which a door of a refrigerator is closed according to an embodiment.

FIG. 2 is a perspective view illustrating a state in which a door of a refrigerator is opened according to an embodiment.

FIG. 3 is a view illustrating an example of an arrangement of door driving devices of a refrigerator according to an embodiment.

FIG. 4 is an internal perspective view of a door driving device provided in a left door of a refrigerator according to an embodiment.

FIG. 5 is a view illustrating an example of a first gear assembly of a door driving device provided in a left door of a refrigerator according to an embodiment.

FIG. 6 is a view illustrating an example of a first gear assembly of a door driving device provided in a left door of a refrigerator according to an embodiment.

FIG. 7 is a view illustrating an example of a clutch gear provided in a first gear assembly of a door driving device of a refrigerator according to an embodiment.

FIG. 8 is a view illustrating an example of a second gear assembly of a door driving device of a refrigerator according to an embodiment.

FIG. 9 is a view illustrating an example of a second gear assembly of a door driving device of a refrigerator according to an embodiment.

FIG. 10 illustrates a network of a refrigerator according to an embodiment.

FIG. 11 is a control block diagram of a refrigerator according to an embodiment.

FIG. 12, FIG. 13 and FIG. 14 illustrate operations of a door driving device when a door of a refrigerator is automatically opened according to an embodiment.

FIG. 15, FIG. 16 and FIG. 17 illustrate operations of a door pusher and a door link provided in a door driving device when a door of a refrigerator is automatically opened according to an embodiment.

FIG. 18 is a flowchart illustrating an example method for controlling a refrigerator according to an embodiment.

FIG. 19 illustrates an example data flow of a refrigerator system including a refrigerator according to an embodiment.

FIG. 20 illustrates a refrigerator control screen provided in a smart appliance application linked to a refrigerator according to an embodiment.

FIG. 21 illustrates an auto door function setting screen provided in a smart appliance application linked to a refrigerator according to an embodiment.

FIG. 22 illustrates a door opening notification window provided in a smart appliance application linked to a refrigerator according to an embodiment.

FIG. 23 illustrates a door closing notification window provided in a smart appliance application linked to a refrigerator according to an embodiment.

FIG. 24 illustrates an abnormal state notification window provided in a smart appliance application linked to a refrigerator according to an embodiment.

FIG. 25 illustrates an example of an operation of opening and closing a door according to an auto door function in a refrigerator according to an embodiment.

FIG. 26 illustrates an example of an operation of providing an abnormal door opening to a smart appliance application during automatic opening of a door in a refrigerator according to an embodiment.

FIG. 27 illustrates an example of an operation of providing an abnormal door closing to a smart appliance application during automatic closing of the door in a refrigerator according to an embodiment.

FIG. 28 is a control block diagram of a server communicating with a refrigerator according to an embodiment.

### MODES OF THE DISCLOSURE

Various embodiments and the terms used therein are not intended to limit the technology disclosed herein to specific forms, and the disclosure should be understood to include various modifications, equivalents, and/or alternatives to the corresponding embodiments.

In describing the drawings, similar reference numerals may be used to designate similar constituent elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

As used herein, the term “and/or” includes any and all combinations of one or more of the associated listed items.

Terms such as “1st”, “2nd”, “primary”, or “secondary” may be used simply to distinguish an element from other elements, without limiting the element in other aspects (e.g., importance or order).

Further, as used in the disclosure, the terms “front”, “rear”, “top”, “bottom”, “side”, “left”, “right”, “upper”, “lower”, and the like are defined with reference to the drawings, and are not intended to limit the shape and position of any element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

A refrigerator according to an embodiment of the disclosure may include a main body.

The “main body” may include an inner case, an outer case positioned outside the inner case, and an insulation provided between the inner case and the outer case.

The “inner case” may include a case, a plate, a panel, or a liner forming a storage compartment (also referred to as a storage room). The inner case may be formed as one body, or may be formed by assembling a plurality of plates together. The “outer case” may form an appearance of the main body, and be coupled to an outer side of the inner case such that the insulation is positioned between the inner case and the outer case.

The “insulation” may insulate an inside of the storage compartment from an outside of the storage compartment to maintain inside temperature of the storage compartment at appropriate temperature without being influenced by an external environment of the storage compartment. According to an embodiment of the disclosure, the insulation may include a foaming insulation. The foaming insulation may be molded by fixing the inner case and the outer case with jigs, etc., and then injecting and foaming urethane foam as a mixture of polyurethane and a foaming agent between the inner case and the outer case.

According to an embodiment of the disclosure, the insulation may include a vacuum insulation in addition to a foaming insulation, or may be configured only with a vacuum insulation instead of a foaming insulation. The vacuum insulation may include a core material and a cladding material accommodating the core material and sealing the inside with vacuum or pressure close to vacuum. However, the insulation is not limited to the above-mentioned foaming insulation or vacuum insulation, and may include various materials capable of being used for insulation.

The “storage compartment” may include a space defined by the inner case. The storage compartment may further include the inner case defining the space corresponding to the storage compartment. The storage compartment may store a variety of items, such as food, medicines, cosmetics, and the like, and the storage compartment may be configured to be open on at least one side for insertion and removal of the items.

The refrigerator may include one or more storage compartments. In a case in which two or more storage compartments are formed in the refrigerator, the respective storage compartments may have different purposes of use, and may be maintained at different temperatures. To this end, the respective storage compartments may be partitioned by a partition wall including an insulation.

The storage compartment may be maintained within an appropriate temperature range according to a purpose of use, and may include a “refrigerating compartment”, a “freezing compartment”, and a “temperature conversion compartment” according to purposes of use and/or temperature ranges. The refrigerating compartment may be maintained at an appropriate temperature to keep food refrigerating, and the freezing compartment may be maintained at an appropriate temperature to keep food frozen. The “refrigerating” may be keeping food cold without freezing the food, and for example, the refrigerating compartment may be maintained within a range of 0 degrees Celsius to 7 degrees Celsius. The “freezing” may be freezing food or keeping food frozen, and for example, the freezing compartment may be maintained within a range of -20 degrees Celsius to -1 degrees Celsius. The temperature conversion compartment may be used as either a refrigerating compartment or a freezing compartment according to or regardless of a user's selection.

The storage compartment may also be referred to by various terms, such as “vegetable compartment”, “freshness compartment”, “cooling compartment”, and “ice-making compartment”, in addition to “refrigerating compartment”, “freezing compartment”, and “temperature conversion compartment”, and the terms, such as “refrigerating compartment”, “freezing compartment”, “temperature conversion compartment”, etc., as used below are to be understood as representing storage compartments having the corresponding purposes of use and the corresponding temperature ranges.

The refrigerator according to an embodiment of the disclosure may include at least one door configured to open or close the open side of the storage compartment. The respective doors may be provided to open and close one or more storage compartments, or a single door may be provided to open and close a plurality of storage compartments. The door may be rotatably or slidably mounted to the front of the main body.

The “door” may seal the storage compartment in a closed state. The door, like the main body, may include an insulation to insulate the storage compartment in a closed state.

According to an embodiment, the door may include an outer door plate forming the front surface of the door, an inner door plate forming the rear surface of the door and facing the storage compartment, an upper cap, a lower cap, and a door insulation provided therein.

A gasket may be provided on the edge of the inner door plate to seal the storage compartment by coming into close contact with the front surface of the main body when the door is closed. The inner door plate may include a dyke that protrudes rearward to allow a door basket for storing items to be fitted.

According to an embodiment, the door may include a door body and a front panel that is detachably coupled to the front of the door body and forming the front surface of the door. The door body may include an outer door plate forming the front surface of the door body, an inner door plate forming the rear surface of the door body and facing the storage compartment, an upper cap, a lower cap, and a door insulator provided therein.

The refrigerator may be classified as French Door Type, Side-by-side Type, Bottom Mounted Freezer (BMF), Top Mounted Freezer (TMF), or Single Door Refrigerator according to the arrangement of the doors and the storage compartments.

The refrigerator according to an embodiment of the disclosure may include a cold air supply device for supplying cold air to the storage compartment.

The “cold air supply device” may include a machine, an apparatus, an electronic device, and/or a combination system thereof, capable of generating cold air and guiding the cold air to cool the storage compartment.

According to an embodiment of the disclosure, the cold air supply device may generate cold air through a cooling cycle including compression, condensation, expansion, and evaporation processes of refrigerants. To this end, the cold air supply device may include a refrigeration cycle device having a compressor, a condenser, an expander, and an evaporator to drive the refrigeration cycle. According to an embodiment of the disclosure, the cold air supply device may include a semiconductor, such as a thermoelectric element. The thermoelectric element may cool the storage compartment by heating and cooling actions through the Peltier effect.

The refrigerator according to an embodiment of the disclosure may include a machine compartment in which at least some components belonging to the cold air supply device are installed.

The “machine compartment” may be partitioned and insulated from the storage compartment to prevent heat generated by the components installed in the machine compartment from being transferred to the storage compartment. To dissipate heat from the components installed in the machine compartment, the machine compartment may communicate with outside of the main body.

The refrigerator according to an embodiment of the disclosure may include a dispenser provided on the door to provide water and/or ice. The dispenser may be provided on the door to allow access by the user without opening the door.

The refrigerator according to an embodiment of the disclosure may include an ice-making device that produces ice. The ice-making device may include an ice-making tray that stores water, an ice-moving device that separates ice from the ice-making tray, and an ice-bucket that stores ice produced in the ice-making tray.

The refrigerator according to an embodiment of the disclosure may include a controller for controlling the refrigerator.

The “controller” may include a memory for storing and/or recording data and/or programs for controlling the refrigerator, and a processor for outputting control signals for controlling the cold air supply device, etc., in accordance with the programs and/or data stored in the memory.

The memory may store or record various information, data, instructions, programs, and the like necessary for operation of the refrigerator. The memory may store temporary data generated while generating control signals for controlling components included in the refrigerator. The memory may include at least one of a volatile memory or a non-volatile memory, or a combination thereof.

The processor may control the overall operation of the refrigerator. The processor may control the components of the refrigerator by executing programs stored in memory. The processor may include a separate neural processing unit (NPU) that performs an artificial intelligence (AI) model operation. In addition, the processor may include a central processing unit (CPU), a graphics processor (GPU), and the like. The processor may generate a control signal to control the operation of the cold air supply device. For example, the processor may receive temperature information of the storage compartment from a temperature sensor and generate a cooling control signal to control an operation of the cold air supply device based on the temperature information of the storage compartment.

Furthermore, the processor may process a user input of a user interface and control an operation of the user interface in accordance with the programs and/or data recorded/stored in the memory. The user interface may be provided with an input interface and an output interface. The processor may receive the user input from the user interface. In addition, the processor may transmit a display control signal and image data for displaying an image on the user interface to the user interface in response to the user input.

The processor and memory may be provided integrally or may be provided separately. The processor may include one or more processors. For example, the processor may include a main processor and at least one sub-processor. The memory may include one or more memories.

The refrigerator according to an embodiment of the disclosure may include a processor and a memory for controlling all of the components included in the refrigerator, and may include a plurality of processors and a plurality of memories for individually controlling the components of the refrigerator. For example, the refrigerator may include a processor and a memory for controlling the operation of the cold air supply device in accordance with to an output of the temperature sensor. In addition, the refrigerator may be separately provided with a processor and a memory for controlling the operation of the user interface in accordance with the user input.

A communication module may communicate with external devices, such as servers, mobile devices, and other home appliances via a nearby access point (AP). The AP may connect a local area network (LAN) to which a refrigerator or a user device is connected to a wide area network (WAN) to which a server is connected. The refrigerator or the user device may be connected to the server via the WAN.

The input interface may include keys, a touch screen, a microphone, and the like. The input interface may receive the user input and pass the received user input to the processor.

The output interface may include a display, a speaker, and the like. The output interface may output various notifications, messages, information, and the like generated by the processor.

Hereinafter, a refrigerator according to various embodiments of the disclosure will be described in detail with reference to the accompanying drawings.

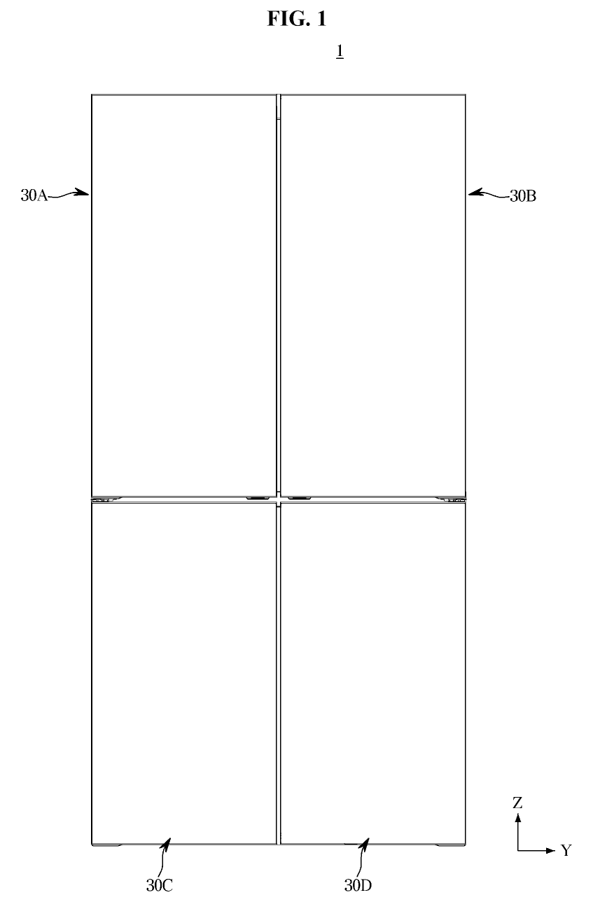

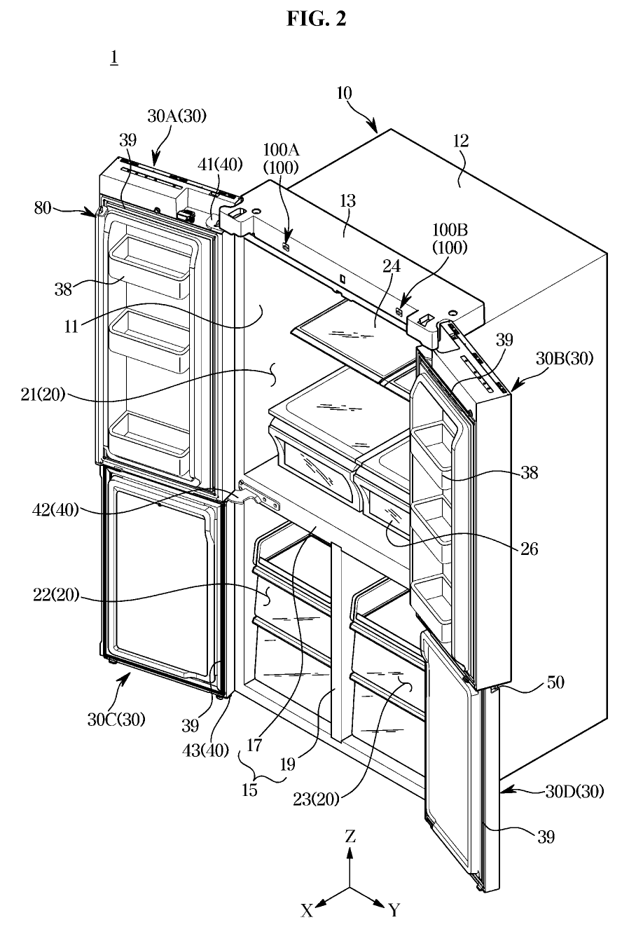

FIG. 1 is a front view illustrating a state in which a door of a refrigerator is closed according to an embodiment of the disclosure. FIG. 2 is a perspective view illustrating a state in which the door of the refrigerator is opened according to an embodiment of the disclosure.

Referring to FIG. 1 and FIG. 2, a refrigerator 1 may include a main body 10, a storage compartment 20 provided inside the main body 10, a door 30 for opening or closing the storage compartment 20, and a cooling system for supplying cold air to the storage compartment 20.

The main body 10 may include an inner case 11 forming the storage compartment 20 and an outer case 12 forming an exterior of the refrigerator 1.

The inner case 11 may be open at the front. The inner case 11 may have the storage compartment 20 therein and may be provided inside the outer case 12. An inner wall of the inner case 11 may form an inner wall of the storage compartment 20.

The outer case 12 may be formed to have a shape of a box with a substantially open front. The outer case 12 may form an upper surface, a lower surface, left and right side surfaces, a rear surface, and the like, of the refrigerator 1.

A main body insulation may be provided between the outer case 12 and the inner case 11 of the main body 10 to insulate the outer case 12 and the inner case 11. The main body insulation may be foamed between the inner case 11 and the outer case 12 to couple the inner case 11 and the outer case 12 to each other. The main body insulation may prevent heat exchange from occurring between the inside of the storage compartment 20 and the outside of the main body 10, thereby improving the cooling efficiency inside the storage compartment 20. As the main body insulation of the main body 10, urethane foam insulation, expanded polystyrene (EPS) insulation, a vacuum insulation panel, or the like may be used. However, the disclosure is not limited thereto, and the main body insulation may be configured to include various materials.

The main body 10 may further include a top table 13 located on an upper portion of the main body 10. Specifically, the top table 13 may be coupled to the upper portion of the outer case 12. The top table 13 may be coupled to an upper side of the outer case 12.

The top table 13 may cover various electronic components. An accommodation space for accommodating various electronic components may be formed in the top table 13. For example, the top table 13 may cover a door driving device 100 to be described later. In this case, the door driving device 100 may be accommodated in the top table 13.

The storage compartment 20 may be provided inside the main body 10. For example, the storage compartment 20 may include a refrigerating compartment maintained at approximately 0 to 5 degrees Celsius to store food in a refrigerated state. For example, the storage compartment 20 may include a freezing compartment maintained at approximately minus 30 to 0 degrees Celsius to store food in a frozen state.

For example, the storage compartment 20 may be divided into a plurality of areas by a partition 15. Specifically, the storage compartment 20 may be divided into an upper first storage compartment 21 and lower storage compartments 22 and 23 by a first partition 17 extending in a horizontal direction.

In addition, the lower storage compartments 22 and 23 of the storage compartment 20 may be divided into the left second storage compartment 22 and the right third storage compartment 23 by a second partition 19 extending in a vertical direction. Here, for example, the first storage compartment 21 may be used as a refrigerating compartment, and the second storage compartment 22 and the third storage compartment 23 may both be used as freezing compartments. Alternatively, one of the second storage compartment 22 and the third storage compartment 23 may be used as a freezing compartment and the other may be used as a refrigerating compartment.

The division method of the storage compartment 20 described above and the use of each of the divided storage compartments 21, 22, and 23 are merely an example and are not limited thereto.

Inside the storage compartment 20, a shelf 24 on which food may be placed and a storage container 26 for storing food may be provided.

The refrigerator 1 may include a cooling system to generate cold air using a cooling cycle and supply the generated cold air to the storage compartment 20. The cooling system may generate cold air using a refrigeration circulation cycle that compresses, condenses, expands, and evaporates refrigerant. For example, the cooling system may include a compressor, a condenser, an expansion valve, an evaporator, a blowing fan, and the like. The cold air generated by the cooling system may be supplied to the storage compartment 20 through a cold air supply duct formed at a rear portion of the inner case 11.

The door 30 may open and close the storage compartment 20. The door 30 may open and close an opening formed on one side of the main body 10. The door 30 may be rotatable with respect to the main body 10.

An outer side of the door 30 may form a part of the exterior of the refrigerator 1. In a position where the door 30 is closed, the outer side of the door 30 may form at least a part of the front exterior of the refrigerator 1. In a state where the door 30 is closed, an inner side of the door 30 may face the inside of the storage compartment 20. The inner side of the door 30 refers to one surface of the door 30 that faces the storage compartment 20 while the door 30 is closing the storage compartment 20. In addition, the outer side of the door 30 refers to the other surface opposite to the inner side of the door 30 that faces the storage compartment 20 while the door 30 is closing the storage compartment 20, and refers to the front surface of the door 30 that is visible when the refrigerator 1 is viewed from the front.

A door basket 38 for storing food may be disposed on the inner side of the door 30. A door gasket 39 may be provided on the inner side of the door 30 to seal a gap between the door 30 and the main body 10 to prevent leakage of cold air from the storage compartment 20.

The refrigerator 1 may include an upper door and a lower door arranged parallel to each other in a vertical direction Z. The refrigerator 1 may include a left door and a right door arranged parallel to each other in a horizontal direction Y. The refrigerator 1 may include a plurality of doors 30A, 30B, 30C, and 30D for opening and closing each of the divided storage compartments 21, 22, and 23.

The first storage compartment 21 may be opened and closed by a pair of upper doors 30A and 30B. The refrigerator 1 may include the first door 30A that opens and closes a portion of the first storage compartment 21, and the second door 30B that opens and closes another portion of the first storage compartment 21. The first door 30A and the second door 30B may be rotatable independently of each other with respect to the main body 10. The first door 30A and the second door 30B may be arranged parallel to each other in the horizontal direction Y direction. For example, the first door 30A may open and close a left portion of the first storage compartment 21, and the second door 30B may open and close a right portion of the first storage compartment 22.

A rotating bar 80 may be provided on one of the pair of upper doors 30A and 30B (for example, the first door 30A). The rotating bar 80 may be rotatable with respect to the one door and may cover a gap between the pair of upper doors 30A and 30B when the pair of upper doors 30A and 30B closes the first storage compartment 21.

The second storage compartment 22 may be opened and closed by the left lower door 30C. The refrigerator 1 may include the third door 30C provided to open and close the second storage compartment 22. The third door 30C may be rotatable with respect to the main body 10. For example, the first door 30A and the third door 30C may be arranged parallel to each other in the vertical direction Z.

The third storage compartment 23 may be opened and closed by the right lower door 30D. The refrigerator 1 may include the fourth door 30D provided to open and close the third storage compartment 23. The fourth door 30D may be rotatable with respect to the main body 10. For example, the second door 30B and the fourth door 30D may be arranged parallel to each other in the vertical direction Z. In addition, the third door 30C and the fourth door 30D may be arranged parallel to each other in the horizontal direction Y.

A handle may be provided on each of the plurality of doors 30A, 30B, 30C, and 30D. A user may open or close each of the doors 30A, 30B, 30C, and 30D by holding the handle provided on each of the plurality of doors 30A, 30B, 30C, and 30D. For example, the handle provided on each of the plurality of doors 30A, 30B, 30C, and 30D may have a groove concavely formed to be gripped.

The handles provided on the third door 30C and the fourth door 30D are described below as an example.

A portion of an upper end side of the third door 30C may include a handle area 50.

The portion of the upper end side of the third door 30C may be a right side of the upper end side of the third door 30C. The right side of the upper end side of the third door 30C may be a surface corresponding to a central area of the main body 10 of the refrigerator.

A front of the handle area 50 of the third door 30C may include a groove portion recessed downward by a predetermined length from the upper end side of the third door.

A user may insert their hand into the groove portion 50 of the third door 30C. The user may open the third door 30C by putting their hand into the groove portion and then pulling the third door. Here, the groove portion may be a handle area.

A portion of an upper end side of the fourth door 30D may include a handle area 50.

The portion of the upper end side of the fourth door 30D may be a left side of the upper end side of the fourth door 30D. The left side of the upper end side of the fourth door 30D may be a surface corresponding to the central area of the main body 10 of the refrigerator.

A front of the handle area 50 of the fourth door 30D may include a groove portion recessed downward by a predetermined length from the upper end side of the fourth door 30D.

A user may insert their hand into the groove portion 50 of the fourth door 30D. The user may open the fourth door 30D by putting their hand into the groove portion 50 and then pulling the fourth door 30D.

As will be described later, the upper door may be opened by the door driving device 100. For example, the first door 30A may be opened by a first door driving device 100A disposed on the left side. For example, the second door 30B may be opened by a second door driving device 100B disposed on the left side.

The refrigerator 1 may include a hinge 40 that connects the main body 10 and the door 30. The hinge 40 may allow the door 30 to be rotatable with respect to the main body 10.

The hinge 40 may be fixed to the main body 10. Specifically, the hinge 40 may be coupled to the outer case 12.

The hinge 40 may rotatably support the door 30. The door 30 may be rotatably coupled to the main body 10 by the hinge 40.

Specifically, the refrigerator 1 may include a plurality of hinges 41, 42, and 43 to support the plurality of doors 30A, 30B, 30C, and 30D, respectively. For example, the refrigerator 1 may include a pair of upper door hinges 41 coupled to an upper portion of the main body 10 to rotatably support the first door 30A and the second door 30B, respectively. In addition, for example, the refrigerator 1 may include a pair of lower door hinges 43 coupled to a lower portion of the main body 10 to rotatably support the third door 30C and the fourth door 30D, respectively. In addition, for example, the refrigerator 1 may include a pair of middle hinges 42 disposed between the upper door hinge 41 and the lower door hinge 43, and coupled to a middle portion of the main body 10 (specifically, to the first partition 17) to rotatably support each of the first door 30A, the second door 30B, the third door 30B, and the fourth door 30D.

The configuration of the refrigerator 1 described above is merely an example of the refrigerator according to an aspect of the disclosure, and the disclosure is not limited thereto.

In addition, although the refrigerator 1 according to an embodiment has been described as an example of the disclosure on the premise that the refrigerator 1 is an indirect cooling refrigerator, the disclosure is not limited thereto, and may be applied to a direct cooling refrigerator.

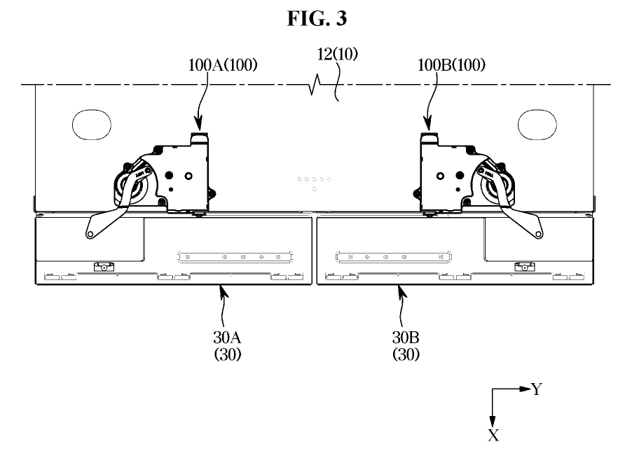

FIG. 3 is a view illustrating an example of an arrangement of door driving devices of a refrigerator according to an embodiment of the disclosure.

Referring to FIG. 3, the refrigerator 1 may include the door driving device 100 provided on the main body 10, specifically on an upper portion of the main body 10.

The door driving device 100 may be provided to move at least one of a plurality of doors of the main body 10. For example, the door driving device 100 may be connected to each of the plurality of doors of the main body to move each of the plurality of doors, or may be connected to two doors of the upper portion of the main body to move the two doors. That is, one or two or more door driving devices 100 may be provided.

In an embodiment, a refrigerator equipped with first and second door driving devices that move the two doors 30A and 30B on the upper portion of the main body, respectively, is described as an example.

The first door driving device 100A and the second door driving device 100B may be accommodated inside the top table 13. The upper sides of the first door driving device 100A and the second door driving device 100B may be covered by the top table 13. The door driving device 100 may be disposed on an upper surface of the outer case 12.

The first door driving device 100A and the second door driving device 100B may be arranged parallel to each other in the horizontal direction Y.

The first door driving device 100A may be disposed on the left side with respect to the center at the upper portion of the main body 10 and may move the first door 30A in a first direction and a second direction to automatically open and close the first storage compartment 21.

The second door driving device 100B may be disposed on the right side with respect to the center at the upper portion of the main body 10 and may move the second door 30B in the first direction and the second direction to automatically open and close the first storage compartment 21.

For example, the first direction may be a moving direction of the first and second doors 30A and 30B to open the storage compartment, and the second direction may be a moving direction of the first and second doors 30A and 30B to close the storage compartment. The first direction of the first door and the first direction of the second door may be different, and the second direction of the first door and the second direction of the second door may be different depending on a direction of an axis of the hinge to which each of the first and second doors is connected.

The first door driving device 100A and the second door driving device 100B may rotationally move (rotate) the first door 30A and the second door 30B, respectively, relative to the main body 10 about the hinge 40 (as a rotational axis).

The first door driving device 100A may apply a repulsive force or an attractive force to the first door 30A, specifically to an upper portion of the first door 30A.

The second door driving device 100B may apply a repulsive force or an attractive force to the second door 30B, specifically to an upper portion of the second door 30B.

More specifically, the first door driving device 100A and the second door driving device 100B may apply a repulsive force to the first door 30A and the second door 30B, respectively, to cause the first door 30A and the second door 30B to rotationally move about the hinge 40, and may apply an attractive force (gravitation) to the first door 30A and the second door 30B, respectively, to cause the first door 30A and the second door 30B to rotationally move about the hinge 40.

The first door driving device 100A may move the first door 30A to cause a part of the first storage compartment 21 to be opened or closed. The second door driving device 100B may move the second door 30B to cause another part of the first storage compartment 21 to be opened or closed.

An operation of the first door driving device 100A moving the first door 30A and an operation of the second door driving device 100B moving the second door 30B may be performed independently of each other.

Hereinafter, a moving state in which the first door 30A and the second door move to open the first storage compartment 21 is described as an open state of the first door 30A and the second door 30B, and a moving state in which the first door 30A and the second door 30B move to close the first storage compartment 21 is described as a closed state of the first door 30A and the second door 30B.

An operation of the first door 30A and the second door 30B to open the first storage compartment 21 is described as opening of the first door 30A and the second door 30B, and an operation of the first door 30A and the second door 30B to close the first storage compartment 21 is described as closing of the first door 30A and the second door 30B.

Although the embodiment is an example in which the door driving device 100 is located on the main body 10 and applies a force to the door to open or close the door, the door driving device 100 may be located on the first and second doors 30A and 30B and applies a force to the main body 10 to open or close the door.

The first door driving device 100A and the second door driving device 100B may have the same structure. The structure of the second door driving device 100B may also be applied to the first door driving device 100A.

Hereinafter, the structure of the first door driving device 100A and the second door driving device 100B are described together as the structure of the door driving device 100. A door moved by the door driving device 100 is described as the door 30.

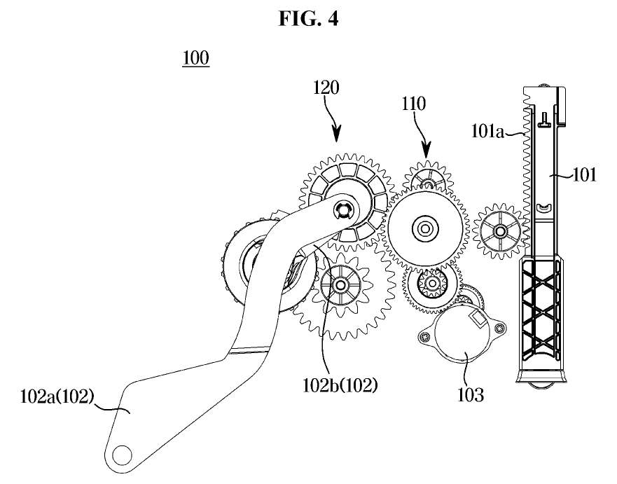

FIG. 4 is an internal perspective view of a door driving device provided in a left door of a refrigerator according to an embodiment.

Referring to FIG. 4, the door driving device 100 may include a door pusher 101, a door link 102, a motor 103, a first gear assembly 110, and a second gear assembly 120.

The door driving device 100 may include a case provided in the top table 13. The case may accommodate the door pusher 101, the motor 103, the first gear assembly 110, and the second gear assembly 120. The door link 102 may be provided outside the case.

The door pusher 101 may apply a repulsive force to the door 30 to open the door 30.

The door pusher 101 may apply a repulsive force to the door 30 while moving relative to the main body 10. Specifically, the door pusher 101 may apply a force to the door 30 while moving forward from the main body 10 side toward the door 30, thereby transitioning the door 30 from a closed state to an open state.

The door pusher 101 may be capable of linear reciprocation with respect to the main body 10. The door pusher 101 may be linearly movable in a front-rear direction X with respect to the main body 10.

The door pusher 101 may apply a physical force to the door 30 while moving from a first position to a second position. Here, the first position may be a position of the door pusher 101 when the door 30 is in the closed state. The first position may be a position when the door pusher 101 is located inside the main body. The second position may be a position of the door pusher 101 when the door is in the open state. The second position may be a position when the door pusher 101 is withdrawn outside the main body.

The door pusher 101 may move from the second position to the first position in a state where the door is completely opened. That is, the door pusher 101 may return to its original position.

The door pusher 101 may include a pusher rack 101a engaged with the first gear assembly 110.

The door pusher 101 may receive power from the first gear assembly 110 through the pusher rack 101a. For example, the first gear assembly 110 and the pusher rack 101a may form a rack-and-pinion gear structure.

The door link 102 may apply an attractive force to the door 30 while moving relative to the main body 10 to close the door 30. Specifically, the door link 102 may apply a force to the door 30 while moving toward the main body 10, thereby transitioning the door 30 from an open state to a closed state.

The door link 102 may be capable of reciprocation with respect to the main body 10.

The door link 102 may be provided outside the case and connected to the second gear assembly 120.

The door link 102 may include a first link 102a connected to the door 30, and a second link 102b connected to the first link 102a and the second gear assembly 120.

The second link 102b may be rotationally moved by the rotation of the second gear assembly 120.

The first link 102a of the door link 102 may be linked to the second link 102b. In this case, the first link 102a of the door link 102 may move in correspondence with the rotation of the second link 102b.

A length of the door link 102 may be decreased as the first link 102a and the second link 102b are bent in correspondence with the rotation of the second link 102b, or may be increased as the bent first link 102a and second link 102b are straightened.

The door link 102 may cause the door 30 to move toward the main body side by bending. The door link 102 may be straightened when the door 30 is opened.

The motor 103 may generate power for the movement of the door pusher 101 and the door link 102.

The door driving device 100 may further include a motor driver connected to the motor 103. The motor 103 may receive a driving current from the motor driver to generate power. The motor driver may be electrically connected to a processor of the refrigerator 1 and may operate based on a control signal received from the controller.

The motor 103 may transmit power to the door pusher 101 using the first gear assembly 110, and may transmit power to the door link 102 using the second gear assembly 120.

The first gear assembly 110 may adjust the rotational force received from the motor 103 to a magnitude of force required for moving the door pusher 101. The force required for moving the door pusher 101 is a force that requires to be applied to the door 30 to open the door 30, and may be greater than or equal to a first reference magnitude.

The first gear assembly 110 may include one or two or more gears that may convert the rotational force of the motor 103 into a force of the first reference magnitude.

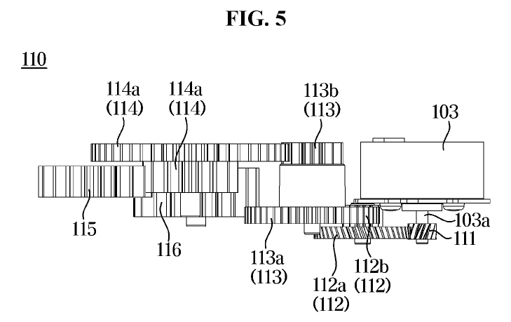

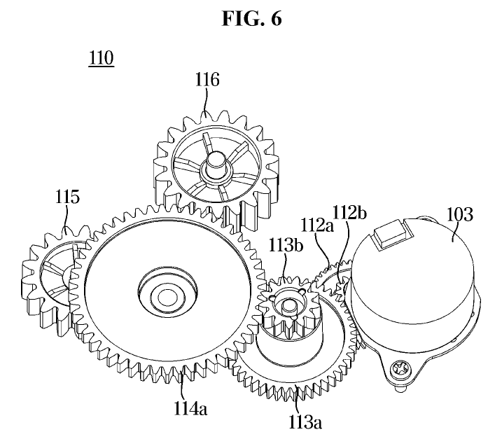

FIG. 5 and FIG. 6 are views illustrating an example of a first gear assembly of a door driving device provided in a left door of a refrigerator according to an embodiment

Referring to FIG. 5 and FIG. 6, the first gear assembly 110 may include a first gear 111 connected to a shaft of the motor 103, a second gear 112 connected to the first gear 111, a third gear 113 connected to the second gear 112, a fourth gear 114 connected to the third gear 113, a fifth gear 115 connected to the fourth gear 114, and a sixth gear 116 connected to the fifth gear 115.

The first gear 111 may include a first helical gear, but the type of the first gear is not limited thereto.

The first gear 111 may be rotated by the rotational force received from the motor 10.

The second gear 112 may include a first double gear. The first double gear may include a second helical gear 112a and a first spur gear 112b.

The second helical gear 112a and the first spur gear 112b of the second gear 112 may have different diameters.

The second helical gear 112a of the second gear 112 may be engaged with the first gear 111, and may be rotated by the rotational force received from the first gear 111.

The first spur gear 112b of the second gear 112 may rotate in conjunction with the second helical gear 112a of the second gear.

The first spur gear 112b of the second gear 112 may be engaged with the third gear 113.

The third gear 113 may include a second double gear. The second double gear may include a second spur gear 113a and a third spur gear 113b. The second and third spur gears 113a and 113b may have different diameters.

The second spur gear 113a of the third gear 113 may be engaged with the first spur gear 112b of the second gear 112, and may be rotated by the rotational force received from the second gear 112.

The third spur gear 113b of the third gear 113 may be engaged with the fourth gear 114.

The third spur gear 113b of the third gear 113 may rotate in conjunction with the second spur gear 113a of the third gear 113.

The fourth gear 114 may include a third double gear. The third double gear may include a fourth spur gear 114a and a fifth spur gear 114b. The fourth and fifth spur gears 114a and 114b may have different diameters.

The fourth spur gear 114a of the fourth gear 114 may be engaged with the third spur gear 113b of the third gear 113, and may be rotated by the rotational force received from the third gear 113.

The fifth spur gear 114b of the fourth gear 114 may be engaged with the fifth gear 115.

The fifth spur gear 114b of the fourth gear 114 may rotate in conjunction with the fourth spur gear 114a of the fourth gear 114.

The types of the second, third, and fourth gears 112, 113, and 114 are not limited to the above examples.

The fifth gear 115 may include a sixth spur gear, but the type of the fifth gear is not limited thereto.

The fifth gear 115 may include a clutch gear.

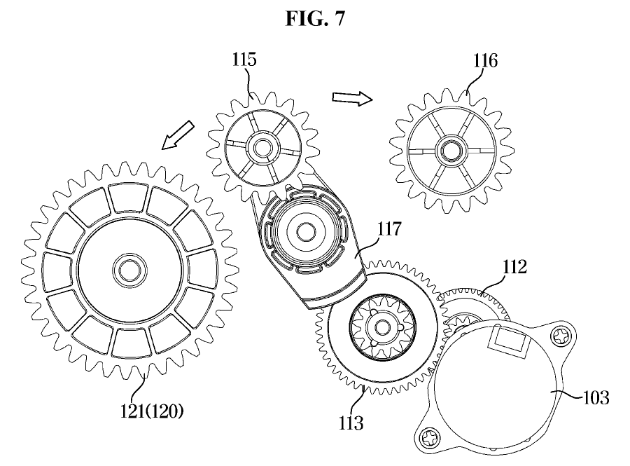

FIG. 7 is a view illustrating an example of a clutch gear provided in a first gear assembly of a door driving device of a refrigerator according to an embodiment.

Referring to FIG. 7, the first gear assembly 110 may further include a moving plate 117 for moving the fifth gear 115.

The fifth gear 115 may be provided on the moving plate 117.

The moving plate 117 may move the fifth gear 115 based on a rotation direction and a rotation angle of the motor 103. That is, the fifth gear 115 may be moved toward the sixth gear 116 side or toward the second gear assembly 120 side by the moving plate 117.

The fifth gear 115 may be connected to the sixth gear 116 when the door 30 is opened, and may be connected to the second gear assembly 120 when the door 30 is closed.

The fifth gear 115 may be connected to the sixth gear 116 even when the door 30 is completely opened.

The fifth gear 115 may transmit the rotational force received from the fourth gear 114 to the sixth gear 116, when connected to the sixth gear 116.

The fifth gear 115 may transmit the rotational force received from the fourth gear 114 to the second gear assembly 120, when connected to the second gear assembly 120.

The sixth gear 116 may include a seventh spur gear, but the type of the sixth gear 116 is not limited thereto.

The sixth gear 116 may be connected to the fifth gear 115 and to the pusher rack 101a of the door pusher 101. The sixth gear 116 and the rack of the door pusher 101 may form a rack-and-pinion gear structure.

The sixth gear 116 may be rotated by the rotational force received from the fifth gear 115, and may transmit the rotational force to the pusher rack 101a of the door pusher 101.

The rotational force transmitted from the sixth gear 116 may be converted into a linear moving force at the pusher rack 101a of the door pusher 101.

The first to sixth gears 111 to 116 may adjust the rotational force received from the motor 103 to a magnitude of force required for moving the door pusher 101.

The first gear assembly 110 may adjust the magnitude of the force transmitted to the door pusher 101 by the gear ratios of the first to sixth gears 111 to 116.

The second gear assembly 120 may adjust the rotational force received from the motor 103 to a magnitude of force required for moving the door link 102. The force required for moving the door link 102 is a force that requires to be applied to the door 30 to close the door 30, and may be greater than or equal to a second reference magnitude.

The second gear assembly 120 may include one or two or more gears that may convert the rotational force of the motor 103 into a force of the second reference magnitude.

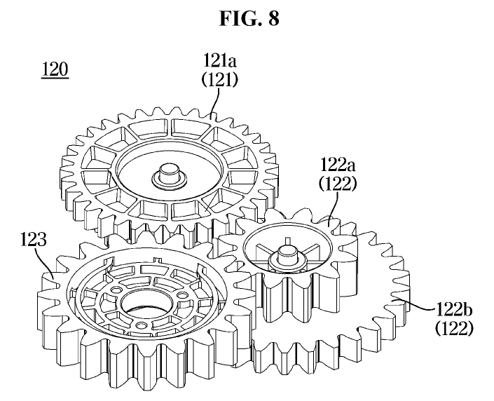

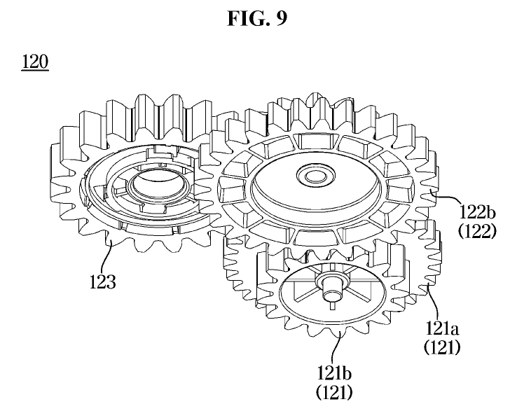

FIG. 8 and FIG. 9 are views illustrating an example of a second gear assembly of a door driving device of a refrigerator according to an embodiment.

Referring to FIG. 8 and FIG. 9, the second gear assembly 120 may include a seventh gear 121 connected to the fifth gear 115 of the first gear assembly 110, an eighth gear 122 connected to the seventh gear 121, and a ninth gear 123 connected to the eighth gear 122.

The seventh gear 121 may include a fourth double gear. The fourth double gear may include an eighth spur gear 121a and a ninth spur gear 121b. The diameters of the eighth and ninth spur gears 121a and 121b may be different.

The eighth spur gear 121a of the seventh gear 121 may be engaged with the fifth gear 115 of the first gear assembly 110, and may be rotated by the rotational force received from the fifth gear 115 of the first gear assembly 110.

The ninth spur gear 121b of the seventh gear 121 may rotate in conjunction with the eighth spur gear 121a of the seventh gear 121.

The ninth spur gear 121b of the seventh gear 121 may be connected to the eighth gear 122.

The eighth gear 122 may include a fifth double gear. The fifth double gear may include a tenth spur gear 122a and an eleventh spur gear 122b. The diameters of the tenth and eleventh spur gears 122a and 122b may be different.

The tenth spur gear 122a of the eighth gear 122 may be engaged with the ninth spur gear 121b of the seventh gear 121, and may be rotated by the rotational force received from the ninth spur gear 121b of the seventh gear 121.

The eleventh spur gear 122b of the eighth gear 122 may rotate in conjunction with the tenth spur gear 122a of the eighth gear 122.

The eleventh spur gear 122b of the eighth gear 122 may be connected to the ninth gear 123, and may transmit rotational force to the ninth gear 123.

The ninth gear 123 may include a twelfth spur gear. The ninth gear 123 may be a link gear.

The ninth gear 123 may be connected to the eleventh spur gear 122b of the eighth gear 122, and may receive rotational force from the eleventh spur gear 122b of the eighth gear 122.

The ninth gear 123 may be connected to the door link 102. A rotational shaft of the ninth gear 123 may be connected to the second link 102b of the door link 102.

The rotational force of the ninth gear 123 may be transmitted to the second link 102b of the door link 102. That is, the second link 102b of the door link 102 may rotate in conjunction with the rotation of the ninth gear 123.

A position of the first link 102a connected to the second link 102b may be changed by the rotation of the second link 102b of the door link 102, and thus a pose of the second link 102b and the first link 102a may be changed.

For example, the second link 102b and the first link 102a may be in a bent pose or an unbent pose in correspondence with a rotation angle of the second link 102b of the door link 102. As a result, an overall length of the door link 102 may increase or decrease.

When the door link 102 is in an unbent pose, the door may be in the open state. When the door link 102 is in a bent pose, the door may be in a closed state.

The seventh, eighth, and ninth gears 121, 122, and 123 may adjust the rotational force received from the motor 103 through the fifth gear 115 to a magnitude of force required for moving the door link 102.

The second gear assembly 120 may adjust the magnitude of the force transmitted to the door link 102 by the gear ratios of the seventh, eighth, and ninth gears 121, 122, and 123.

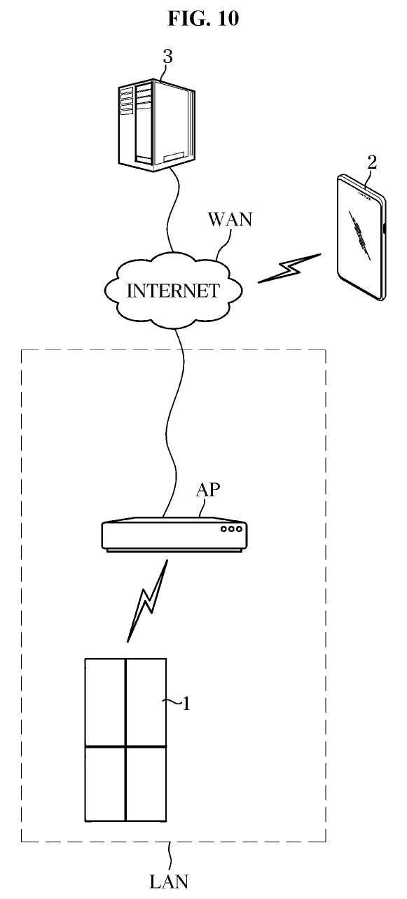

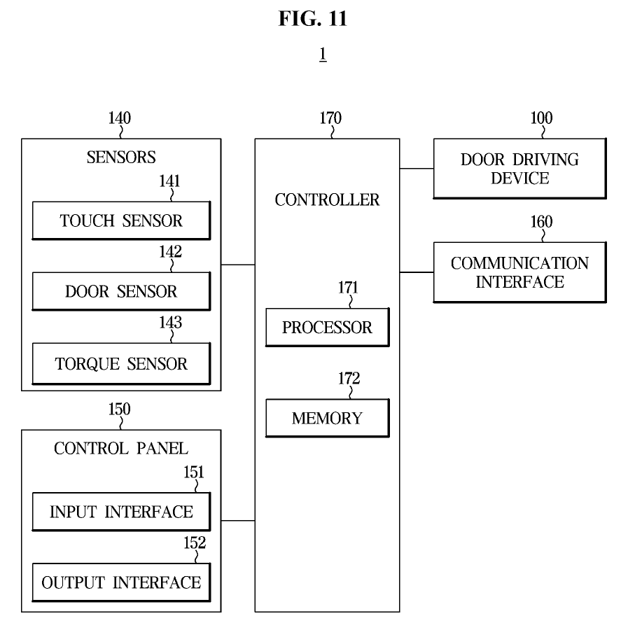

FIG. 10 illustrates a network of a refrigerator according to an embodiment.

Referring to FIG. 10, the refrigerator 1 may communicate with another home appliance (not shown), a user device 2, or a server 3.

The other home appliance may be at least one of various types of home appliances. For example, the other home appliance may include at least one of a dishwasher, an electric range, an electric oven, an air conditioner, a clothes treating apparatus, a washing machine, a dryer, and a microwave oven, but is not limited thereto. For example, the home appliance may include various types of appliances not shown in the drawings, such as a cleaning robot, a vacuum cleaner, a television, and the like. Furthermore, the aforementioned home appliances are by way of example only.

The server 3 may include a communication module communicating with another server, the refrigerator 1, or the user device 2, at least one processor that processes data received from the other server, the refrigerator 1, or the user device 2, and at least one memory that stores programs for processing data or processed data. The server 3 may be implemented as a variety of computing devices, such as a workstation, a cloud, a data drive, a data station, and the like. The server 3 may be implemented as one or more server physically or logically separated based on a function, detailed configuration of function, or data, and may transmit and receive data through communication between servers and process the transmitted and received data.

The server 3 may perform functions, such as managing a user account, registering the refrigerator 1 in association with the user account, managing or controlling the registered refrigerator 1, and the like. For example, a user may access the server 3 via the user device 2 and may create a user account. The user account may be identified by an identifier (ID) and a password set by the user. The server 3 may register the refrigerator 1 with the user account according to a predetermined procedure. For example, the server 3 may link identification information of the refrigerator 1 (e.g., a serial number or MAC address) to the user account to register, manage, and control the refrigerator 1.

The user device 2 may include a communication module capable of communicating with the refrigerator 1 or the server 3, a user interface that receives a user input or outputs information to a user, at least one processor that controls an operation of the user device 2, and at least one memory that stores a program for controlling the operation of the user device 2.

The user device 2 may be carried by a user, or placed in a user's home or office, or the like. The user device 2 may include a personal computer (PC), a terminal, a portable telephone, a smartphone, a handheld device, a wearable device, and the like, but is not limited thereto.

The memory of the user device 2 may store a program for controlling the refrigerator 1, i.e. An application. The application may be sold installed on the user device 2, or may be downloaded from an external server for installation.

By running the application installed on the user device 2 by a user, the user may access the server 3, create a user account, and communicate with the server 3 based on the login user account to register the refrigerator 1.

For example, by operating the refrigerator 1 to allow the refrigerator 1 to access the server 3 according to a procedure guided by the application installed on the user device 2, the server 3 may register the refrigerator 1 with the user account by assigning the identification information (e.g., a serial number or a MAC address) of the refrigerator 1 to the corresponding user account.

A user may control the refrigerator 1 using the application installed on the user device 2. For example, by logging into a user account with the application installed on the user device 2, the refrigerator 1 registered in the user account appears, and by inputting a control command for the refrigerator 1, the control command may be delivered to the refrigerator 1 via the server 3.

A network may include both a wired network and a wireless network. The wired network may include a cable network or a telephone network, and the wireless network may include any networks transmitting and receiving a signal via radio waves. The wired network and the wireless network may be interconnected.

The network may include a wide area network (WAN), such as the Internet, a local area network (LAN) formed around an access point (AP), and a short-range wireless network that does not use an AP. The short-range wireless network may include Bluetooth^{TM} (IEEE 802.15.1), Zigbee (IEEE 802.15.4), Wi-Fi Direct, near field communication (NFC), and Z-Wave, but is not limited thereto.

The AP may connect the refrigerator 1 or the user device 2 to a WAN connected to the server 3. The refrigerator 1 or the user device 2 may be connected to the server 3 via a WAN.

The AP may communicate with the refrigerator 1 or the user device 2 using wireless communication, such as Wi-Fi^{TM} (IEEE 802.11), Bluetooth^{TM} (IEEE 802.15.1), Zigbee (IEEE 802.15.4), and the like, and access a WAN using wired communication, but is not limited thereto.

According to various embodiments, the refrigerator 1 may be directly connected to the user device 2 or the server 3 without going through an AP.

The refrigerator 1 may be connected to the user device 2 or the server 3 via a long-range wireless network or a short-range wireless network.

For example, the refrigerator 1 may be connected to the user device 2 via a short-range wireless network (e.g., Wi-Fi Direct).

In another example, the refrigerator 1 may be connected to the user device 2 or the server 3 via a WAN using a long-range wireless network (e.g., a cellular communication module).

In still another example, the refrigerator 1 may access a WAN using wired communication, and may be connected to the user device 2 or the server 3 via a WAN.

When accessing a WAN using wired communication, the refrigerator 1 may also act as an AP. Accordingly, the refrigerator 1 may connect another home appliance to a WAN to which the server 3 is connected. In addition, the other home appliance may connect the refrigerator 1 to the WAN to which the server 3 is connected.

The refrigerator 1 may transmit information about an operation or state to the other home appliance, the user device 2, or the server 3 via the network. For example, the refrigerator 1 may transmit information about an operation or state to the other home appliance, the user device 2 or the server 3 upon receiving a request from the server 3, in response to an event in the refrigerator 1, or periodically or in real time. Upon receiving the information about the operation or state from the refrigerator 1, the server 3 may update the stored information about the operation or state of the refrigerator 1 and transmit the updated information about the operation and state of the refrigerator 1 to the user device 2 via the network. Here, updating the information may include various operations in which existing information is changed, such as adding new information to the existing information, replacing the existing information with new information, and the like.

The refrigerator 1 may obtain various information from the other home appliance, the user device 2, or the server 3, and may provide the obtained information to a user. For example, the refrigerator 1 may obtain information related to a function of the refrigerator 1 and various environmental information (e.g., weather, temperature, humidity, etc.) from the server 3, and may output the obtained information via a user interface.

The refrigerator 1 may operate in accordance with a control command received from the other home appliance, the user device 2, or the server 3. For example, the refrigerator 1 may operate in accordance with a control command received from the server 3, based on a prior authorization obtained from a user to operate in accordance with the control command of the server 3 even without a user input. Here, the control command received from the server 3 may include a control command input by the user via the user device 2 or a control command based on preset conditions, but is not limited thereto.

The user device 2 may transmit information about a user to the refrigerator 1 or the server 3 via the communication module. For example, the user device 2 may transmit information about a user's location, a user's health condition, a user's preference, a user's schedule, and the like to the server 3. The user device 2 may transmit information about the user to the server 3 based on the user's prior authorization.

The refrigerator 1, the user device 2, or the server 3 may use techniques, such as artificial intelligence (AI) to determine a control command. For example, the server 3 may receive information about an operation or a state of the refrigerator 1 or information about a user of the user device 2, process the received information using techniques, such as AI, and transmit a processing result or a control command to the refrigerator 1 or the user device 2 based on the processing result.

FIG. 11 is a control block diagram of the refrigerator according to an embodiment.

Referring to FIG. 11, the refrigerator 1 may include the door driving device 100, a plurality of sensors 140, a control panel 150, a communication interface 160, and a controller 170.

The plurality of sensors 140 may include a touch sensor 141, a door sensor 142, a torque sensor 143, and the like.

The touch sensor 141 is provided on the door 30, and may detect a user's touch. The touch sensor 141 may detect the user's touch operation for automatically opening and closing the door 30. For example, the touch sensor 141 may include a capacitive touch sensor or an optical touch sensor. The controller 170 may identify whether the user's touch operation for automatically opening the door 30 or the user's touch operation for automatically closing the door 30 based on an output value of the touch sensor 141.

The door sensor 142 may detect whether the door 30 is open or closed. For example, the door sensor 142 may output 1 when the door 30 is open, and may output 0 when the door 30 is closed. For example, the door sensor 142 may also be implemented as a distance sensor. In this case, the door sensor 142 may output different output values according to the distance between the door 30 and the main body 10. The controller 170 may determine whether the door 30 is in an open state or a closed state based on the output value of the door sensor 142.

The torque sensor 143 may detect a torque of the motor 103 of the door driving device 100. The torque sensor 143 may output an output value corresponding to a torque of the rotating shaft of the motor 103. The controller 170 may identify whether a resistance force generated upon contact with an obstacle is generated, based on the output value of the torque sensor 143, when the door 30 is automatically opened and closed. In various embodiments, instead of the torque sensor 143, a person or an obstacle interfering with the automatic opening and closing of the door 30 may be detected through an infrared sensor, a radar, or the like.

According to various embodiments, the refrigerator 1 may further include various types of sensors in addition to the sensors described above.

The control panel 150 may obtain various user inputs, and output various information about the operation of the refrigerator 1. The control panel 150 may include an input interface 151 and an output interface 152.

The input interface 151 may convert sensory information received from a user into an electrical signal. For example, the input interface 151 may include a tact switch, a push switch, a slide switch, a toggle switch, a micro switch, a touch switch, a touch pad, a touch screen, a jog dial, and/or a microphone.

The output interface 152 may visually or audibly transmit information related to the operation of the refrigerator 1 to a user. Information about the operation of the refrigerator 1 may be output via a screen, an indicator, or a voice. The output interface 152 may include a liquid crystal display (LCD) panel, a light emitting diode (LED) panel, or a speaker.

The communication interface 160 may include at least one component that enables communication with an external device. For example, the communication interface 160 may include at least one of a short-range wireless communication module or a long-range wireless communication module. The external device may include the user device 2 or the server 3.

The door driving device 100 may automatically open or close the door 30.

The controller 170 may include hardware, such as a central processing unit (CPU), Micom (e.g., microcontroller unit (MCU), microprocessor unit (MPU)), at least one processor 171, and at least one memory 172, and software such as a control program. For example, the controller 170 may include at least one memory 172 that stores data in the form of a program or an algorithm for controlling operations of components in the refrigerator 1, and at least one processor 171 that performs the above-described operations and operations to be described below using the data stored in the at least one memory 172. The memory 172 and the processor 171 may be implemented as separate chips. The processor 171 may include one or two or more processor chips or one or two or more processing cores. The memory 172 may include one or two or more memory chips or one or two or more memory blocks. In addition, the memory 172 and processor 171 may be implemented as a single chip.

The memory 172 may include a volatile memory, such as static random access memory (SRAM) or dynamic random access memory (DRAM), for temporary storage of data, and a non-volatile memory, such as read only memory (ROM), erasable programmable read only memory (EPROM), or electrically erasable programmable read only memory (EEPROM), for long-term storage of data.

The controller 170 may automatically open or automatically close the door 30 by driving the motor 103 of the door driving device 100 to rotate the first gear assembly 110 and the second gear assembly 120. For example, the controller 170 may automatically open the door 30 by rotating the motor 103 in the first rotation direction, and may automatically close the door 30 by rotating the motor 103 in the second rotation direction. The first rotation direction may be opposite to the second rotation direction. For example, when the first rotation direction is clockwise, the second rotation direction may be counterclockwise. As another example, when the first rotation direction is counterclockwise, the second rotation direction may be clockwise.

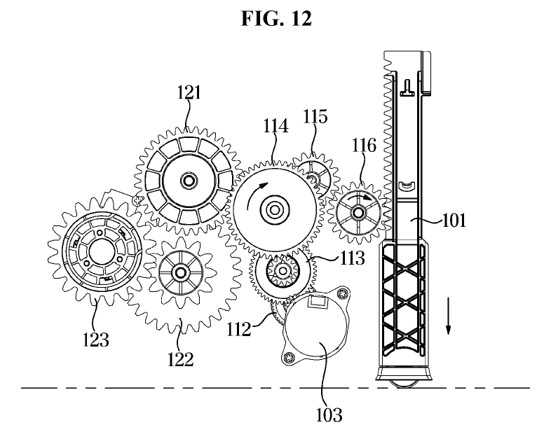

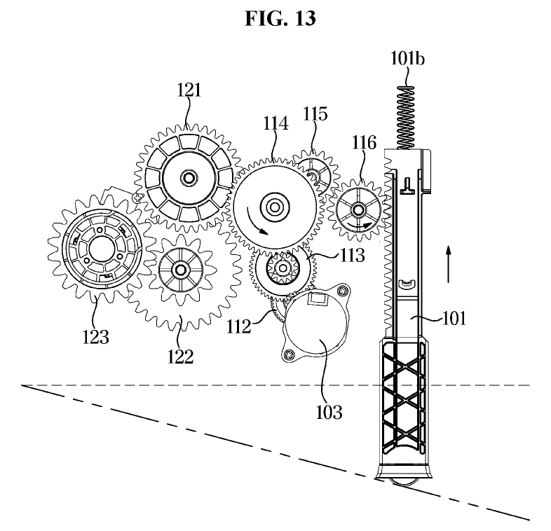

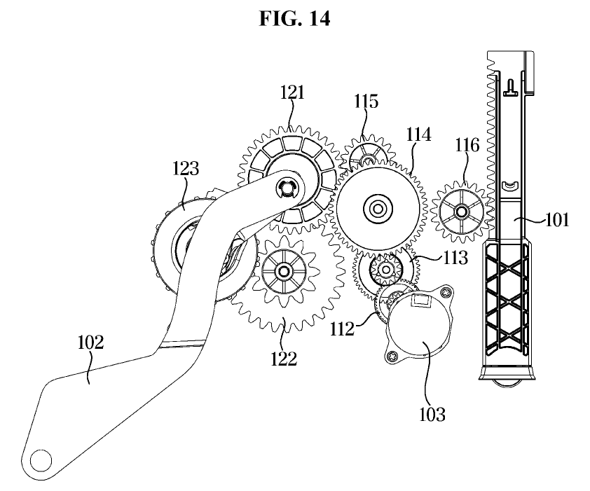

The operation of the first assembly 110 of the door driving device 100 for the automatic opening of the door 30 is described with reference to FIG. 12 to FIG. 14.

FIG. 12, FIG. 13 and FIG. 14 illustrate the operation of the door driving device when the door of the refrigerator is automatically opened according to an embodiment.

Referring to FIG. 12, the fifth gear 115 of the first gear assembly 110 may be engaged with the sixth gear 116 by the motor 103 rotating in the first rotation direction.

The power generated by the motor 103 may be transmitted to the sixth gear 116 through the first to fifth gears 111 to 115.

The sixth gear 116 may be rotated by the power transmitted through the fifth gear 115. The rotational force generated by the rotation of the sixth gear 116 may be transmitted to the pusher rack 101b of the door pusher 101. The rotational force of the sixth gear 116 may be converted into a linear moving force in a first moving direction at the pusher rack 101b of the door pusher 101.

The door pusher 101 may move from a first position to a second position by the generated linear moving force in the first moving direction. The door pusher 101 may protrude forward of the main body 10 by the movement of the door pusher 101 in the first moving direction, and may apply a repulsive force to the door 30.

The door 30 may be separated from the main body 10 by the applied repulsive force, thereby opening the storage compartment.

Referring to FIG. 13, once the door 30 is completely opened, the fifth gear 115 may be maintained in the state of being engaged with the sixth gear 116 by the elastic force of the elastic member 102b provided in the door pusher 101.

The power generated by the motor 103 rotating in the second rotation direction may be transmitted to the first to fifth gears 111 to 115 and the sixth gear 116. However, as the motor 103 is changed to rotate in the second rotation direction, the rotation direction of the first to fifth gears 111 to 115 and the sixth gear 116 may also be changed.

The rotational force generated by the rotation of the sixth gear 116 may be transmitted to the pusher rack 101b of the door pusher 101. The pusher rack 101b of the door pusher 101 may convert the rotational force transmitted from the sixth gear 116 into a linear moving force. In this case, the pusher rack 101b of the door pusher 101 may generate a linear moving force of a second moving direction by the change in the rotation direction of the sixth gear 116. The second moving direction may be opposite to the first moving direction.

The door pusher 101 may move from the second position to the first position by the moving force in the second moving direction. The door pusher 101 may be inserted into the main body 10 by the movement of the door pusher 101 in the second moving direction.

Referring to FIG. 14, once the door pusher 101 is completely inserted, the elastic force of the elastic member 102b provided in the door pusher 101 is released, and the fifth gear 115 may be separated from the sixth gear 116.

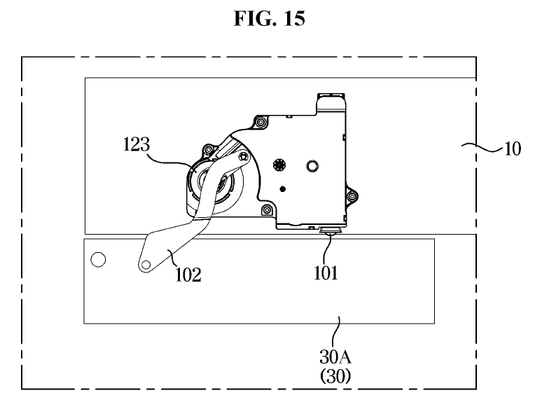

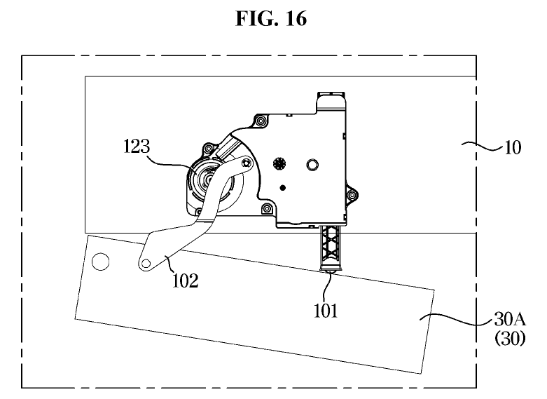

In addition, an operation of the door link 102 of the door driving device 100 during automatic opening of the door 30 is described with reference to FIG. 15 to FIG. 17.

FIG. 15, FIG. 16 and FIG. 17 illustrate the operation of the door pusher and the door link provided in the door driving device when the door of the refrigerator is automatically opened according to an embodiment.

Referring to FIG. 15, when the door 30 is in the closed state, the first link 102a and the second link 102b of the door link 102 may be in an overlapping pose. That is, the first link 102a and the second link 102b of the door link 102 may be in a bent pose. As a result, a length of the door link 102 may become a first length.

Referring to FIG. 16, when the door 30 starts to open, the door pusher 101 may be protruded from the main body 10, and the door 30 may move due to a repulsive force applied to the door 30 by the protruding door pusher 101.

A moving force of the door 30 moved by the door pusher 101 is transmitted to the door link 102, and the ninth gear 123 of the second gear assembly 120 rotates in the first rotation direction by the moving force transmitted to the door link 102. That is, the second link 102b also rotates in the first rotation direction by the moving force transmitted to the first link 102a of the door link 102.

Referring to FIG. 17, when the door 30 is completely opened, the door pusher 101 may be inserted into the main body 10.

When the door 30 is in a completely open state, the first link 102a and the second link 102b of the door link 102 may be in the stretched pose. That is, the first link 102a and the second link 102b of the door link 102 may be in the unbent pose. As a result, the length of the door link 102 may become a second length. The second length may be longer than the first length.

The door link 102 may have the second length by the opening of the door 30, or may have the first length by the closing of the door 30.

Referring back to FIG. 11, when the touch operation for automatically opening the door 30 is detected through the touch sensor 141, the controller 170 may automatically open the door 30 through the door driving device 100. When the touch operation for automatically closing the door 30 is detected through the touch sensor 141, the controller 170 may automatically close the door 30 through the door driving device 100.

Based on receiving a user command for automatically opening the door 30 through the control panel 150, the controller 170 may automatically open the door 30 through the door driving device 100. Based on receiving a user command for automatically closing the door 30 through the control panel 150, the controller 170 may automatically close the door 30 through the door driving device 100.

The controller 170 may detect whether the door 30 is open or closed through the door sensor 142 during the automatic opening and closing of the door 30, and may notify the user of the opening and closing state of the door 30 through the control panel 150.

The controller 170 may detect a torque of the motor 103 through the torque sensor 143 during the automatic opening and closing of the door 30. In addition, based on the torque of the motor 103 being greater than a preset value, the controller 170 may identify that a resistance force has occurred due to contact with an obstacle, and notify the user that an abnormal door opening and closing has occurred through the control panel 150.

The controller 170 may receive setting information about the auto door function and an auto door command from an external device through the communication interface 160.

The controller 170 may automatically open or close the door 30 with a door opening speed value, a door closing speed value, a door opening delay value (ex, a door opening time delay value), a door closing delay value (ex, a door closing time delay value), a door alarm volume, and the like, which are set according to the received setting information about the auto door function and the auto door command.

The controller 170 may transmit the opening and closing state of the door 30 to the external device through the communication interface 160 so that the user may confirm the opening and closing state of the door 30 through the smart appliance application linked to the refrigerator 1 while automatically opening and closing the door 30 according to the setting information about the auto door function.

The controller 170 may transmit an abnormal operation of the door 30 to the external device through the communication interface 160 so that the user may confirm an abnormal operation of the door 30 through the smart appliance application linked to the refrigerator 1 while automatically opening and closing the door 30 according to the setting information about the auto door function.

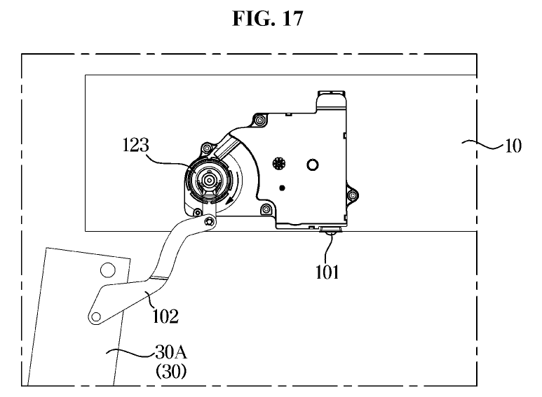

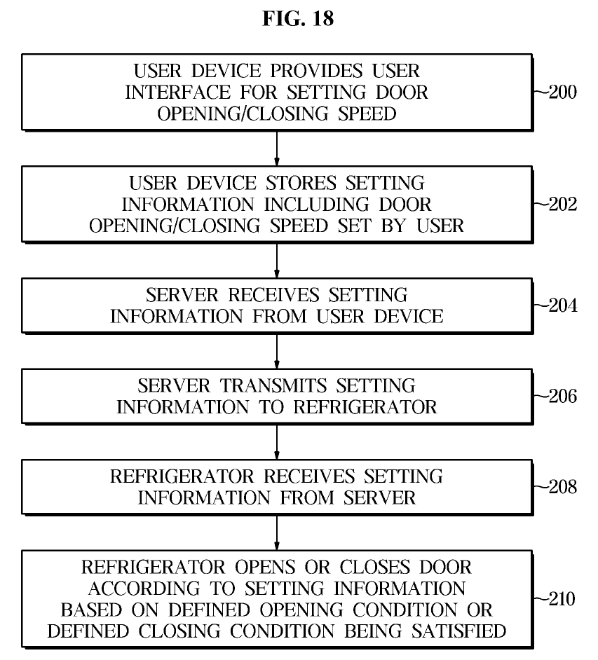

FIG. 18 is a flowchart illustrating an example method for controlling a refrigerator according to an embodiment.

Referring to FIG. 18, the refrigerator 1 is communicatively connected to the server 3. The server 3 is communicatively connected to the user device 2. The refrigerator 1 may directly communicate with the user device 2.

The method for controlling the refrigerator according to an embodiment may include an operation 200 in which the user device 2 may provide a user interface for setting at least one of an opening speed or a closing speed of the door 30.

The user device 2 may have the smart appliance application installed for remotely controlling the refrigerator 1 or confirming a state of the refrigerator 1. The user device 2 may provide the user interface for setting the opening speed, the closing speed, and the like, of the door 30 using the smart appliance application. The smart appliance application may receive a user input for setting the opening speed, the closing speed, and the like, of the door 30. The smart appliance application may set the opening speed, the closing speed, and the like, of the door 30 according to the user input. In addition, the smart appliance application may provide the user interface for further setting the auto door functions, such as a door opening delay, a door closing delay, and a door alarm volume, in addition to the door opening speed and the door closing speed.

The method for controlling the refrigerator according to an embodiment may include an operation 202 in which the user device 2 stores setting information, including at least one of the opening speed or the closing speed, set by the user.

The smart appliance application of the user device 2 may store the setting information, including the opening speed, the closing speed, and the like, set by the user. In addition, the smart appliance application may further store the setting information about the auto door functions, such as the door opening delay, the door closing delay, and the door alarm volume, set by the user.

The method for controlling the refrigerator according to an embodiment may include an operation 204 in which the server 3 receives the setting information from the user device 2.

The user device 2 may transmit the setting information, including the opening speed, the closing speed, and the like, set by the user to the server 3.

The server 3 may receive the setting information, including the opening speed, the closing speed, and the like, set by the user from the user device 2.

The method for controlling the refrigerator according to an embodiment may include an operation 206 in which the server 3 transmits the received setting information to the refrigerator 1.

The server 3 may transmit the setting information, including the opening speed, the closing speed, and the like, set by the user to the refrigerator 1.

The method for controlling the refrigerator according to an embodiment may include an operation 208 in which the refrigerator 1 receives the setting information from the server 3.

The refrigerator 1 may receive the setting information, including the opening speed, the closing speed, and the like, set by the user from the server 3.

The refrigerator 1 may store the setting information received from the server 3.

The refrigerator 1 may change or update the existing setting information in the refrigerator 1 according to the setting information received from the server 3. For example, the existing opening speed or closing speed may be changed to the received opening speed or closing speed.

The method for controlling the refrigerator according to an embodiment may include an operation 210 in which the refrigerator 1 opens or closes the door 30 according to the received setting information based on a defined opening condition or a defined closing condition being satisfied.

The defined opening condition may include the condition for opening the door 30 of the refrigerator 1.

The refrigerator 1 may determine that the defined opening condition is satisfied when a condition in which a touch operation for automatically opening the door 30 is detected through the touch sensor 141 is satisfied.

The refrigerator 1 may determine that the defined opening condition is satisfied when a condition in which a user command for automatically opening the door 30 is received through the control panel 150 is satisfied.

The refrigerator 1 may determine that the defined opening condition is satisfied when a condition in which a door opening command is received from the server 3 through the communication interface 160 is satisfied.

The defined closing condition may include the condition for closing the door 30 of the refrigerator 1.

The refrigerator 1 may determine that the defined closing condition is satisfied when a condition in which a touch operation for automatically closing the door 30 is detected through the touch sensor 141 is satisfied.

The refrigerator 1 may determine that the defined closing condition is satisfied when a condition in which a user command for automatically closing the door 30 is received through the control panel 150 is satisfied.

The refrigerator 1 may determine that the defined closing condition is satisfied when a condition in which a door closing command is received from the server 3 through the communication interface 160 is satisfied.

The refrigerator 1 may open or close the door 30 according to the received setting information based on the defined opening condition or the defined closing condition being satisfied. For example, based on the defined opening condition being satisfied, the door 30 may be opened according to the received opening speed. In addition, based on the defined closing condition being satisfied, the door 30 may be closed according to the received closing speed. In addition, in a case where the setting information includes the door opening delay, the refrigerator 1 may open the door 30 in response to an elapse of the received door opening delay from a time point at which the defined opening condition is satisfied. In addition, in a case where the setting information includes the door closing delay, the refrigerator 1 may close the door 30 in response to an elapse of the received door closing delay from a time point at which the defined closing condition is satisfied. In addition, in a case where the setting information includes the door alarm volume, the door alarm sound of the received door alarm volume may be output when opening or closing the door 30, based on the defined opening condition or the defined closing condition being satisfied.

In addition, the method for controlling the refrigerator according to an embodiment may further include an operation in which the refrigerator 1 transmits state information about an operating state of the door 30 to the user device 2 via the server 3 while opening or closing the door 30 according to the received setting information.

The state information about the operating state of the door 30 may include at least one of an opening state, an opening progress rate, a closing state, or a closing progress rate of the door 30.

The refrigerator 1 may transmit at least one of the opening state, the opening progress rate, the closing state, or the closing progress rate to the server 3 while opening or closing the door 30 according to the received setting information.

In addition, the method for controlling the refrigerator according to an embodiment may further include an operation in which the user device 2 provides a user interface for notifying the state information based on receiving the state information from the server 3.

The user device 2 may provide a notification window for notifying the user of at least one of the opening state, the opening progress rate, the closing state, or the closing progress rate through the smart appliance application.

In addition, the method for controlling the refrigerator according to an embodiment may further include an operation in which the refrigerator 1 transmits abnormal operation information about an abnormal operation of the door 30 to the server 3, based on identifying the abnormal operation of the door 30 while opening or closing the door 30 according to the received setting information.

In addition, the method for controlling the refrigerator according to an embodiment may further include an operation in which the user device 2 provides a user interface for notifying the abnormal operation information based on receiving the abnormal operation information from the server 3.

The user device 2 may provide a notification window for notifying the user of the abnormal operation information through the smart appliance application.

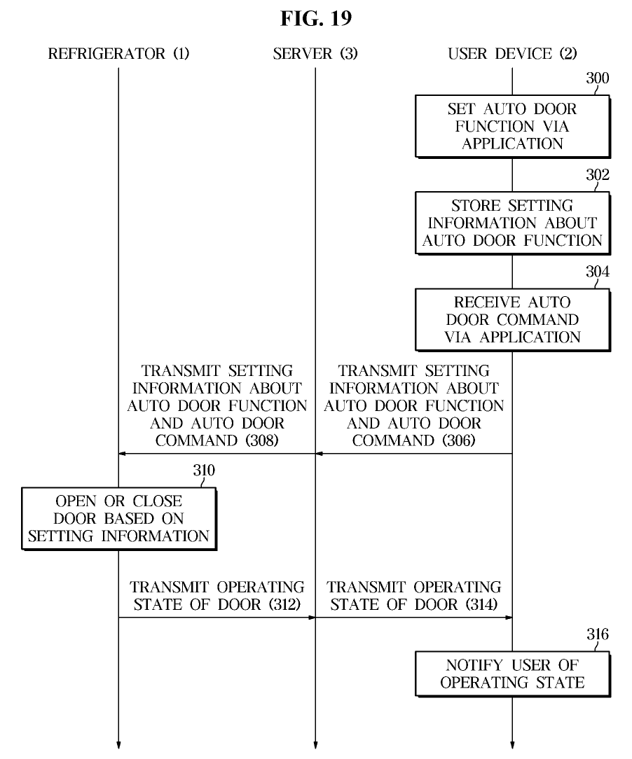

FIG. 19 illustrates an example data flow of the refrigerator system including the refrigerator according to an embodiment.

Referring to FIG. 19, the refrigerator system may include the refrigerator 1, the server 3, and the user device 2 communicatively connected to each other.

A user may set the auto door function for automatically opening and closing the door 30 of the refrigerator 1 using a smart appliance application installed on the user device 2.

The auto door function may include a door opening speed, a door closing speed, a door opening delay, a door closing delay, a door alarm volume, and the like.

The user device 2 may set the auto door function of the refrigerator 1 according to a user input (300).

The user device 2 may store setting information about the auto door function set by the user (302). The setting information about the auto door function may include a door opening speed value, a door closing speed value, a door opening delay value, a door closing delay value, a door alarm volume, and the like.

The user device 2 may receive an auto door command from the user (304). The auto door command may be a command for automatically opening or closing the door 30 of the refrigerator 1. For example, the auto door command may include a door opening command or a door closing command. The door opening command may be the user's command for automatically opening the door of the refrigerator 1. The door closing command may be the user's command for automatically closing the door of the refrigerator 1.

The user device 2 may transmit the setting information about the auto door function and the auto door command to the server 3 (306).

The server 3 may receive the setting information about the auto door function and the auto door command from the user device 2. The server 3 may transmit the received setting information about the auto door function and the auto door command to the refrigerator 1 (308).

The refrigerator 1 may receive the setting information about the auto door function and the auto door command from the server 3. The refrigerator 1 may change the existing setting information with the received setting information about the auto door function. The refrigerator 1 may open or close the door 30 of the refrigerator 1 according to the auto door command based on the setting information about the auto door function (310). For example, the refrigerator 1 may automatically open the door 30 according to the door opening command based on the door opening speed value, the door opening delay value, and the door alarm volume. In addition, the refrigerator 1 may automatically close the door 30 according to the door closing command based on the door closing speed value, the door closing delay value, and the door alarm volume.

The refrigerator 1 may collect state information about an operating state of the door (hereinafter, also referred to as ‘door operating state’) while opening or closing the door, and transmit the state information to the server 3 (312). The door operating state may include an opening state, an opening progress rate, a closing state, a closing progress rate, an abnormal door operation, and the like.

The server 3 may receive the state information about the door operating state of the refrigerator 1 from the refrigerator 1. The server 3 may transmit the received state information about the door operating state to the user device 2 (314).

The user device 2 may receive the state information about the door operating state of the refrigerator 1 from the server 3. The user device 2 may provide the state information about the door operating state of the refrigerator 1 to the smart appliance application.

The user device 2 may notify the user of the state information about the door operating state of the refrigerator 1 (316).

The user device 2 may display the state information about the door operating state, such as the opening state, the opening progress rate, the closing state, the closing progress rate, and the abnormal door operation of the door 30 through the smart appliance application.

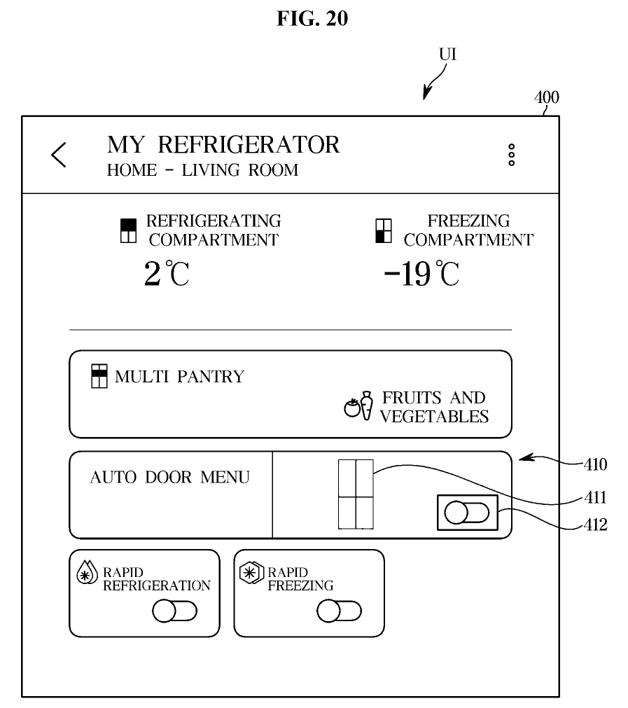

FIG. 20 illustrates a refrigerator control screen provided in the smart appliance application linked to the refrigerator according to an embodiment.

Referring to FIG. 20, the user device 2 may provide a user interface (UI) for setting the auto door function using the smart appliance application.

When a user taps "My Refrigerator" among the controllable home appliances on the home screen of the smart appliance application, a refrigerator control screen 400 for controlling the refrigerator 1 named "My Refrigerator" may be displayed.

The refrigerator control screen 400 may include an auto door menu item 410 for controlling the auto door menu of the refrigerator 1.

The auto door menu item 410 may include a setting button 411 for displaying the current opening state or the current closing state of the door 30 of the refrigerator 1, as well as the setting screen for setting the auto door function. The setting button 411 may be in the form of an icon representing the refrigerator or a text-based button.

In addition, the auto door menu item 410 may include a quick opening and closing button 412 for quickly opening or closing the door 30 of the refrigerator 1.

In addition, the refrigerator control screen 400 may display a current refrigerating compartment temperature value, a current freezing compartment temperature value, current setting information of multi pantry of the refrigerator 1, and the like. The refrigerator control screen 400 may include buttons for controlling rapid refrigeration, rapid freezing, and the like.

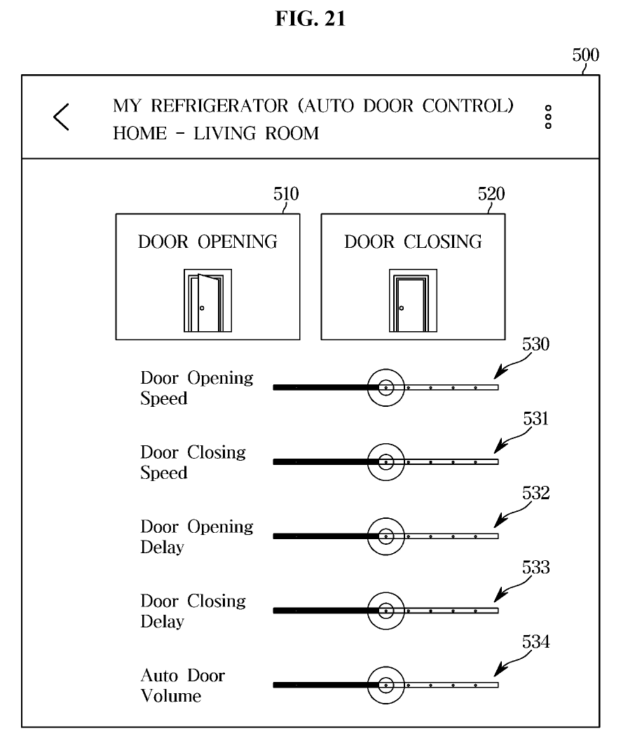

FIG. 21 illustrates an auto door function setting screen provided in the smart appliance application linked to the refrigerator according to an embodiment.

Referring to FIG. 21, the smart appliance application may display an auto door function setting screen 500 when a user taps the setting button 411 of the auto door menu item 410 on the refrigerator control screen 400.

The auto door function setting screen 500 may include a door opening button 510, a door closing button 520, a door opening speed item 530, a door closing speed item 531, a door opening delay item 532, a door closing delay item 533, a door alarm volume (or auto door volume) item 534, and the like.

The door opening button 510 may be a button for receiving a door opening command for automatically opening the door 30 of the refrigerator 1.

The door closing button 520 may be a button for receiving a door closing command for automatically closing the door 30.

The door opening speed item 530 may be a graphic element for receiving an opening speed of the door 30 when the door 30 is automatically opened. The user may adjust the desired opening speed by moving the slider of the door opening speed item 530. The speed of opening the door 30 may need to be set differently depending on the situation. For example, in the case of children or the elderly, a slow opening speed may be required to prevent collisions during automatic opening for safety. In addition, in the case of adults, a fast opening speed may be required for quick automatic opening. Therefore, the door opening speed suitable for the user's environment may be selected, thereby improving safety and convenience.

The door closing speed item 531 may be a graphic element for receiving a closing speed of the door 30 when the door 30 is automatically closed. The user may adjust the desired closing speed by moving the slider of the door closing speed item 531. The speed of closing the door 30 may need to be set differently depending on the situation. For example, in the case of children or the elderly, a slow closing speed may be required to prevent collisions during automatic closing of the door 30 for safety. In addition, in the case of adults, a fast closing speed may be required for quick automatic closing. Therefore, the door closing speed suitable for the user's environment may be selected, thereby improving safety and convenience.

The door opening delay item 532 may be a graphic element for receiving a delay time before opening the door 30 when the door 30 is automatically opened. The user may adjust the desired door opening delay by moving the slider of the door opening delay item 532. A short delay may be required before the door 30 is automatically opened. For example, a person may be standing in front of the door 30 or an obstacle may be present when the door 30 is automatically opened. Therefore, the door 30 may not be opened immediately but may be opened after a short door opening delay. As a result, unnecessary additional door opening may be prevented, thereby reducing energy consumption and preventing safety accidents.

The door closing delay item 533 may be a graphic element for receiving a delay time before closing the door 30 when the door 30 is automatically closed. The user may adjust the desired door closing delay by moving the slider of the door closing delay item 533. A short delay may be required before the door 30 is automatically closed. For example, a person may be standing in front of the door 30 or an obstacle may be present when the door 30 is automatically closed. Therefore, the door 30 may not be closed immediately but may be closed after a short door closing delay. As a result, unnecessary additional door closing may be prevented, thereby reducing energy consumption and preventing safety accidents.

The door alarm volume item 534 may be a graphic element for receiving a volume of alarm sound that indicates that the door 30 is in operation when the door 30 is automatically opened or closed. The user may adjust the desired door alarm volume by moving the slider of the door alarm volume item 534. The door alarm sound may include at least one of a door opening sound or a door closing sound. The volume of the door alarm sound may vary depending on the surrounding environment and the user's preference. For example, some users may prefer a small sound in a quiet environment and a loud sound in a noisy environment. Therefore, the sound volume suitable for the user's environment may be selected, and customized experience may be provided to increase user satisfaction.

The user device 2 may store the setting information about the auto door function, including the door opening speed value, the door closing speed value, the door opening delay value, the door closing delay value, and the door alarm volume, which are set by the user, on the auto door function setting screen 500 of the smart appliance application.

Based on receiving an auto door command such as a door opening command or a door closing command from the user on the auto door function setting screen 500 of the smart appliance application, the user device 2 may transmit the setting information about the auto door function along with the auto door command to the refrigerator 1 via the server 3.

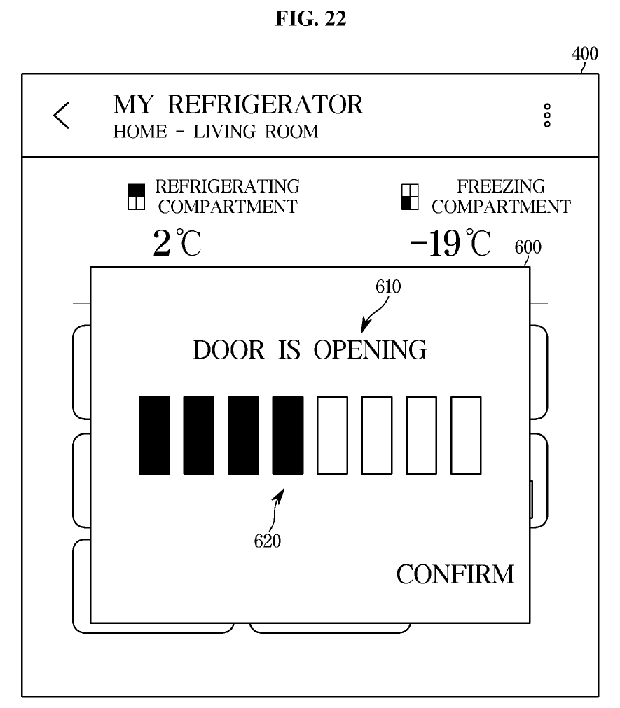

FIG. 22 illustrates a door opening notification window provided in the smart appliance application linked to the refrigerator according to an embodiment.

Referring to FIG. 22, the user device 2 may receive a door opening state from the refrigerator 1 when the door 30 of the refrigerator 1 is being automatically opened, and may display a door opening notification window 600 to notify the door opening state on the refrigerator control screen 400.

The door opening notification window 600 may include a guidance text (message) 610 indicating that the door 30 is opening and a progress bar 620.

For example, the guidance text 610 may include the phrase "The Door is Opening".

The progress bar 620 may display an opening degree of the door 30 in the form of a bar.

The progress bar 620 may be filled according to the opening speed and the opening delay of the door 30.

By displaying the door opening notification window 600 on the refrigerator control screen 400 of the smart appliance application, the user device 2 may allow the user to confirm the automatic opening state of the door 30 even when the user automatically opens the door 30 using the smart appliance application from outside, and may intuitively confirm the opening speed, the opening delay, and the like.

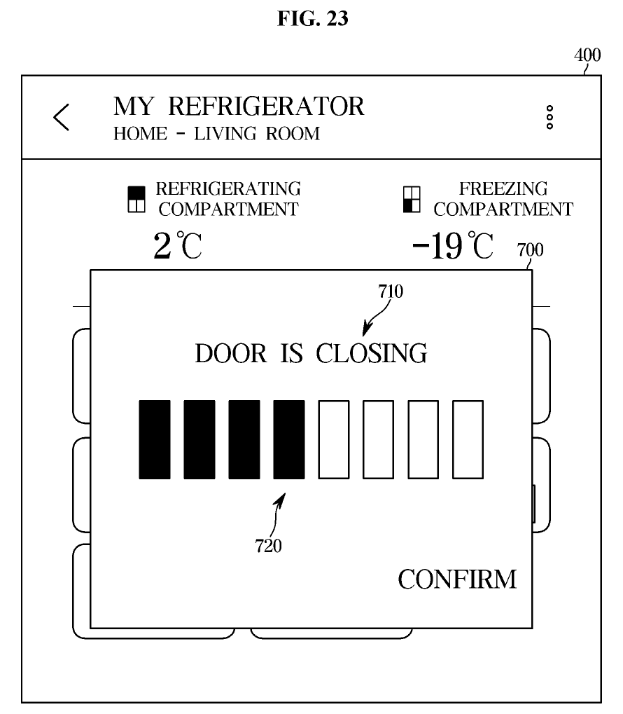

FIG. 23 illustrates a door closing notification window provided in the smart appliance application linked to the refrigerator according to an embodiment.

Referring to FIG. 23, the user device 2 may receive a door closing state from the refrigerator 1 when the door 30 of the refrigerator 1 is being automatically closed, and may display a door closing notification window 700 indicating the door closing state on the refrigerator control screen 400.

The door closing notification window 700 may include a guidance text 710 indicating that the door 30 is being closed and a progress bar 720.

For example, the guidance text 710 may include the phrase "The Door is Closing".

The progress bar 720 may display a closing degree of the door 30 in the form of a bar.

The progress bar 720 may be filled according to the closing speed and the closing delay of the door 30.

By displaying the door closing notification window 700 on the refrigerator control screen 400 of the smart appliance application, the user device 2 may allow the user to confirm the automatic closing state of the door 30 even when the user automatically closes the door 30 using the smart appliance application from outside, and intuitively confirm the closing speed, closing delay, and the like.

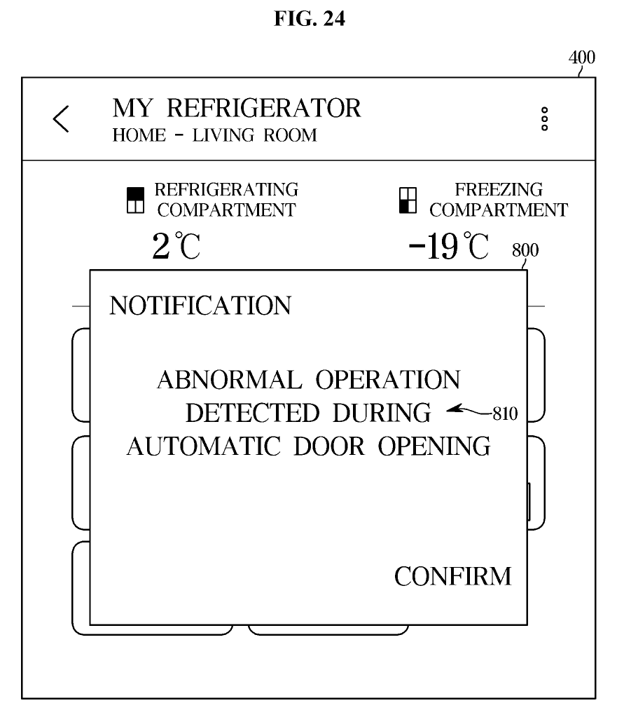

FIG. 24 illustrates an abnormal state notification window provided in the smart appliance application linked to the refrigerator according to an embodiment.

Referring to FIG. 24, the user device 2 may receive an abnormal door state caused by colliding between the door 30 and a person or an obstacle from the refrigerator 1 via the server 2 while the door 30 of the refrigerator 1 is being automatically opened or closed, and may display an abnormal door state notification window 800 indicating the abnormal door state on the refrigerator control screen 400.

The abnormal door state notification window 800 may include a guidance text 810 indicating that the door 30 is in an abnormal state.

For example, the guidance text 810 may include the phrase "Abnormal operation detected during automatic door opening." In addition, the guidance text 810 may include the phrase "Abnormal operation detected during automatic door closing."

By displaying the abnormal door state notification window 800 on the refrigerator control screen 400 of the smart appliance application, the user device 2 may allow the user to confirm the abnormal state of the door 30 even when the user automatically closes the door 30 using the smart appliance application from outside, and intuitively confirm the closing speed, closing delay, and the like.

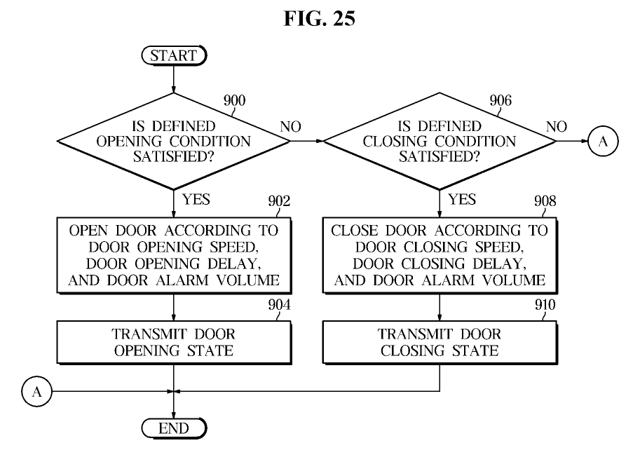

FIG. 25 illustrates an example of an operation of opening and closing the door according to the auto door function in the refrigerator according to an embodiment.

Referring to FIG. 25, the refrigerator 1 may determine whether a defined opening condition is satisfied (900).

In response to the defined opening condition being satisfied (Yes in operation 900), the refrigerator 1 may set a door opening speed, a door opening delay, a door alarm volume based on setting information about the auto door function, and may open the door 30 according to the door opening speed, the door opening delay, and the door alarm volume (902).

When opening the door 30, the refrigerator 1 may transmit an door opening state to the server 3 to provide the door opening state to the smart appliance application of the user device 2 (904). Accordingly, the server 3 may receive the door opening state and transmit the door opening state to the user device 2, thereby providing the door opening state to the smart appliance application.

In addition, the refrigerator 1 may determine whether a defined closing condition is satisfied (906).

In response to the defined closing condition being satisfied (Yes in operation 906), the refrigerator 1 may set a door closing speed, a door closing delay, and a door alarm volume based on setting information about the auto door function, and may close the door 30 according to the door closing speed, the door closing delay, and the door alarm volume (908).

When closing the door 30, the refrigerator 1 may transmit a door closing state to the server 3 to provide the door closing state to the smart appliance application of the user device 2 (910). Accordingly, the server 3 may receive the door closing state and transmit the door closing state to the user device 2, thereby providing the door closing state to the smart appliance application.

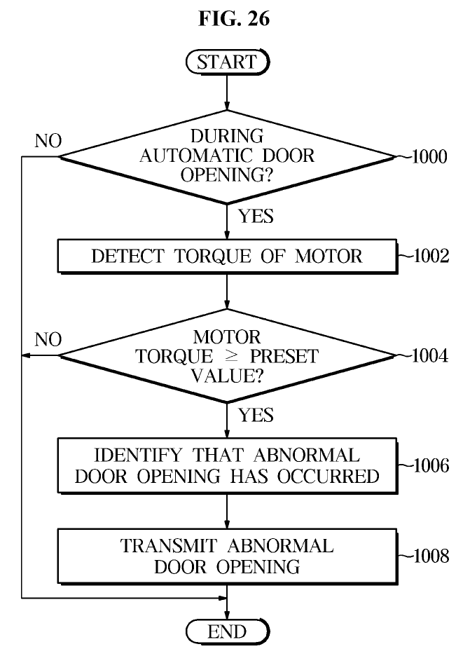

FIG. 26 illustrates an example of an operation of providing an abnormal door opening to the smart appliance application during automatic door opening in the refrigerator according to an embodiment.

Referring to FIG. 26, during automatic door opening (1000), the refrigerator 1 may detect a torque of the motor 103 of the door driving device 100 through the torque sensor 143 (1002).

Based on the torque of the motor 103 being greater than or equal to a preset value (Yes in operation 1004), the refrigerator 1 may identify that an abnormal door opening has occurred due to contact between the door 30 and a person or an obstacle while the door 30 is opened (1006). In this case, the refrigerator 1 may stop the motor 103 to temporarily or completely stop the door opening.

The refrigerator 1 may transmit the abnormal door opening to the server 3 to provide the abnormal door opening to the smart appliance application of the user device 2 (1008). Accordingly, the server 3 may receive the abnormal door opening and transmit the abnormal door opening to the user device 2, thereby providing the abnormal door opening to the smart appliance application of the user device 2.

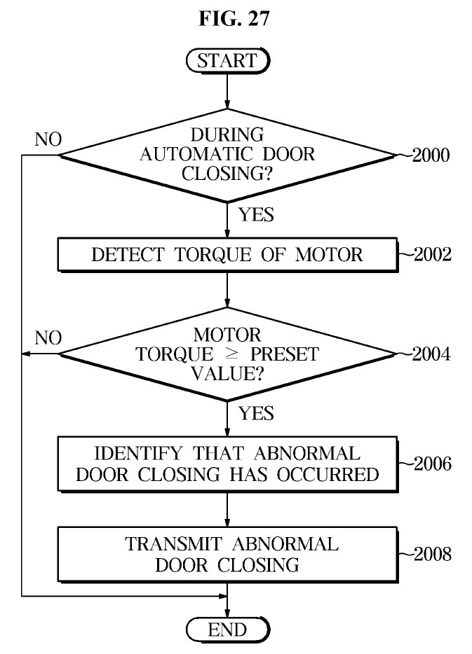

FIG. 27 illustrates an example of an operation of providing an abnormal door closing to the smart appliance application during automatic door closing in the refrigerator according to an embodiment.

Referring to FIG. 27, during automatic door closing (2000), the refrigerator 1 may detect a torque of the motor 103 of the door driving device 100 through the torque sensor 143 (2002).

Based on the torque of the motor 103 being greater than or equal to a preset value (Yes in operation 2004), the refrigerator 1 may identify that an abnormal door closing has occurred due to contact between the door 30 and a person or an obstacle while the door 30 is closed (2006). In this case, the refrigerator 1 may stop the motor 103 to temporarily or completely stop the door closing.

The refrigerator 1 may transmit the abnormal door opening to the server 3 to provide the abnormal door closing to the smart appliance application of the user device 2 (2008). Accordingly, the server 3 may receive the abnormal door closing and transmit the abnormal door opening to the user device 2, thereby providing the abnormal door opening to the smart appliance application of the user device 2.

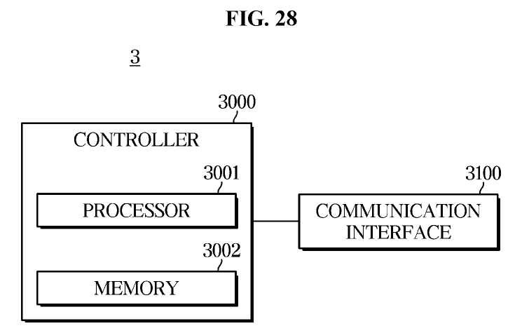

FIG. 28 is a control block diagram of the server communicating with the refrigerator according to an embodiment.

Referring to FIG. 28, the server 3 may include a controller 3000 and a communication interface 3100.

The communication interface 3100 may include one or more components that enable communication with the refrigerator 1 or the user device 2. For example, the communication interface 3100 may include at least one of a short-range wireless communication module, a wired communication module, or a wireless communication module.

The controller 3000 may include hardware such as a CPU, a Micom (e.g., microcontroller unit (MCU), microprocessor unit (MPU)), at least one processor 3001, and at least one memory 3002, and software such as a control program.

The controller 3000 may receive setting information about the auto door function and an auto door command from the user device 2 linked to the server 3 through the communication interface 3100. Therefore, the refrigerator 1 may perform door opening or door closing of the refrigerator 1 according to the auto door command based on the setting information about the auto door function. For example, the refrigerator 1 may automatically open the door 30 according to a door opening command based on a door opening speed value, a door opening delay value, and a door alarm volume. In addition, the refrigerator 1 may automatically close the door 30 according to a door closing command based on a door closing speed value, a door closing delay value, and a door alarm volume.

The controller 3000 may transmit the setting information about the auto door function and the auto door command to the refrigerator 1 linked to the server 3.

The controller 3000 may receive a door operating state from the refrigerator 1.

The controller 3000 may transmit the door operating state, such as a door opening state, an opening progress rate, a door closing state, a closing progress rate, an abnormal door opening, and an abnormal door closing of the refrigerator 1 to the user device 2. Therefore, the smart appliance application of the user device 2 may notify the user of the door operating state of the refrigerator 1.

According to the disclosure, the refrigerator may remotely control the auto door function, implement various auto door functions, and monitor an operating state of the door in real time using a smart appliance application.

According to the disclosure, the refrigerator may adjust an opening speed, closing speed, door opening delay, door closing delay, and door alarm volume using a smart appliance application.

According to the disclosure, the refrigerator may detect an abnormal operation of a door when automatically opening or closing the door using a smart appliance application and notify a user of the abnormal operation through the smart appliance application.

According to an embodiment of the disclosure, a refrigerator 1 may include: a main body 10 including a storage compartment 20; a door 30 rotatable to open or close the storage compartment 20; a door driving device 100 configured to open or close the door 30; a communication interface 160 configured to communicate with an external device 2 and/or 3; and a controller 170 configured to: receive setting information from the external device 2 and/or 3 through the communication interface 160, the setting information including at least one of an opening speed of the door 30, a closing speed of the door 30, an opening delay of the door 30 from a time point at which a defined opening condition is satisfied, or a defined closing delay of the door 30 from a time point at which a defined closing condition is satisfied, and control the door driving device 100 to open or close the door 30 according to the received setting information, based on the defined opening condition or the defined closing condition being satisfied.

The controller 170 may be configured to: control the door driving device 100 to open the door 30 in response to an elapse of the opening delay from the time point at which the defined opening condition is satisfied, and control the door driving device 100 to close the door 30 in response to an elapse of the closing delay from the time point at which the defined closing condition is satisfied.

The setting information may further include a volume of an alarm sound, and the controller 170 may be configured to output the alarm sound at the volume while controlling the door driving device 100 to open or close the door 30.

The controller 170 may be configured to transmit state information about an operating state of the door 30 to the external device 2 and/or 3 through the communication interface 160 while opening or closing the door 30 according to the received setting information.

The state information may further include at least one of an opening state, an opening progress rate, a closing state, or a closing progress rate, and the controller 170 may be configured to: transmit at least one of the opening state or the opening progress rate to the external device 2 and/or 3 through the communication interface 160 while opening the door 30 according to the received setting information, and transmit at least one of the closing state or the closing progress rate to the external device 2 and/or 3 through the communication interface 160 while closing the door 30 according to the received setting information.

The controller 170 may be configured to transmit abnormal operation information about an abnormal operation of the door 30 to the external device 2 and/or 3 through the communication interface 160, based on identifying the abnormal operation of the door 30 while opening or closing the door 30 according to the received setting information.

The abnormal operation information may further include at least one of abnormal opening or abnormal closing, and the controller 170 may be configured to: transmit the abnormal opening to the external device 2 and/or 3 through the communication interface 160, based on identifying the abnormal opening while opening the door 30 according to the received setting information, and transmit the abnormal closing to the external device 2 and/or 3 through the communication interface 160, based on identifying the abnormal closing while closing the door 30 according to the received setting information.

The door driving device 100 may include a motor 103, a door pusher 101 configured to move to open the door 30 by the motor 103, and a door link 102 configured to move to close the door 30 by the motor 103, the refrigerator 1 may further include: a torque sensor 143 configured to detect a torque of the motor 103, and the controller 170 may be configured to: identify the abnormal opening of the door 30 based on a motor torque detected by the torque sensor 143 being greater than or equal to a preset value while opening the door 30 according to the received setting information, and identify the abnormal closing of the door 30 based on a motor torque detected by the torque sensor 143 being greater than or equal to the preset value while closing the door 30 according to the received setting information.

The controller 170 may be configured to control the door driving device 100 to stop the door 30, based on identifying the abnormal operation of the door 30 while opening or closing the door 30 according to the received setting information.

The controller 170 may be configured to: determine that the defined opening condition is satisfied, based on a condition in which a touch operation for opening the door 30 is detected through a touch sensor provided on the door 30, a condition in which a user command for opening the door 30 is received through a control panel, or a condition in which a door opening command for opening the door 30 is received from the external device 2 and/or 3 through the communication interface 160 being satisfied, and determine that the defined closing condition is satisfied, based on a condition in which a touch operation for closing the door 30 is detected through the touch sensor provided on the door 30, a condition in which a user command for closing the door 30 is received through the control panel, or a condition in which a door closing command for closing the door 30 is received from the external device 2 and/or 3 through the communication interface 160 being satisfied.

According to an embodiment of the disclosure, a method for controlling a refrigerator 1 may include: providing, by a user device 2, a user interface (UI) for setting at least one of an opening speed of a door 30 of the refrigerator 1, a closing speed of the door 30, an opening delay of the door 30 from a time point at which a defined opening condition is satisfied, or a defined closing delay of the door 30 from a time point at which a defined closing condition is satisfied; storing, by the user device 2, setting information including at least one of the opening speed, the closing speed, the opening delay, or the closing delay which are set by a user; receiving, by a server 3, the stored setting information from the user device 2; transmitting, by the server 3, the received setting information to the refrigerator 1; receiving, by the refrigerator 1, the setting information transmitted from the server 3; and opening or closing, by the refrigerator 1, the door 30 according to the received setting information, based on the defined opening condition or the defined closing condition being satisfied.

The providing of the user interface may include providing a setting screen 500 for setting the setting information through a smart appliance application installed on the user device 2, and the setting screen 500 may include at least one of an opening speed item 530 or a closing speed item 531 operable by the user.

The setting screen 500 may further include at least one of an opening delay item 532 or a closing delay item 533 operable by the user.

The setting information may further include a volume of an alarm sound, and the setting screen 500 may further include an alarm sound volume item 534 operable by the user.

The opening or closing of the door 30 may include: determining that the defined opening condition is satisfied, based on a condition in which a touch operation for opening the door 30 is detected through a touch sensor 141 provided on the door 30, a condition in which a user command for opening the door 30 is received through a control panel 150, or a condition in which a door opening command for opening the door 30 is received from the server 3 through a communication interface 160 being satisfied, or determining that the defined closing condition is satisfied, based on a condition in which a touch operation for closing the door 30 is detected through the touch sensor 141 provided on the door 30, a condition in which a user command for closing the door 30 is received through the control panel 150, or a condition in which a door closing command for closing the door 30 is received from the server 3 through the communication interface 160 being satisfied.

The method may further include: transmitting, by the refrigerator 1, state information about an operating state of the door 30 to the server 3 while opening or closing the door 30 according to the received setting information.

The state information may further include at least one of an opening state, an opening progress rate, a closing state, or a closing progress rate, and the transmitting of the state information may include: transmitting at least one of the opening state, the opening progress rate, the closing state, or the closing progress rate to the server 3 while opening or closing the door 30 according to the received setting information.

The method may further include: providing, by the user device 2, a user interface (UI) for notifying the state information based on the state information being received from the server 3, and the providing of the user interface may include providing a notification window 600 or 700 for notifying a user of at least one of the opening state, the opening progress rate, the closing state, or the closing progress rate through a smart appliance application installed on the user device 2.

The method may further include: transmitting, by the refrigerator 1, abnormal operation information about an abnormal operation of the door 30 to the server 3, based on identifying the abnormal operation of the door 30 while opening or closing the door 30 according to the received setting information.

The method may further include: providing, by the user device 2, a user interface (UI) for notifying the abnormal operation of the door 30 based on the abnormal operation information being received from the server 3, and the providing of the user interface may include providing a notification window 800 for notifying the user of the abnormal operation information through the smart appliance application installed on the user device 2.

Meanwhile, the disclosed embodiments may be implemented in the form of a recording medium that stores instructions executable by a computer. The instructions may be stored in the form of program codes, and when executed by a processor, the instructions may generate a program module to perform the operations of the disclosed embodiments.

The machine-readable storage medium may be provided in the form of a non-transitory storage medium. Here, when a storage medium is referred to as "non-transitory", it may be understood that the storage medium is tangible and does not include a signal (e.g., an electromagnetic wave), but rather that data is semi-permanently or temporarily stored in the storage medium. For example, a "non-transitory storage medium" may include a buffer in which data is temporarily stored.

The method according to various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed (e.g., download or upload) through an application store (e.g., Play Store^{TM}) online or directly between two user devices (e.g., smartphones). In the case of online distribution, at least a portion of the computer program product (e.g., downloadable app) may be stored at least semi-permanently or may be temporarily generated in a storage medium, such as a memory of a server of a manufacturer, a server of an application store, or a relay server.

Although embodiments of the disclosure have been described with reference to the accompanying drawings, a person having ordinary skilled in the art will appreciate that other specific modifications may be easily made without departing from the technical spirit or essential features of the disclosure. Therefore, the foregoing embodiments should be regarded as illustrative rather than limiting in all aspects.

1. A refrigerator, comprising:
a main body including a storage compartment;
a door configured to rotate to open or close the storage compartment;
a door driving device configured to open or close the door;
a communication interface configured to communicate with an external device; and
a controller configured to:
receive setting information from the external device through the communication interface, the setting information including at least one received setting information item among setting information items to set an opening speed of the door, a closing speed of the door, an opening time delay of the door from a time point at which an opening condition is satisfied, or a closing time delay of the door from a time point at which a closing condition is satisfied, and
control the door driving device such that the door is opened or closed, based on the opening condition or the closing condition being satisfied, and according to the at least one received setting information item among the setting information items.

2. The refrigerator of claim 1, wherein the controller is configured to:
control the door driving device to open the door in response to an elapse of the opening time delay from the time point at which the opening condition is satisfied, and
control the door driving device to close the door in response to an elapse of the closing time delay from the time point at which the closing condition is satisfied.

3. The refrigerator of claim 1, wherein the setting information further includes an information item to set a volume of an alarm sound, and
the controller is configured to output the alarm sound at the volume while controlling the door driving device to open or close the door.

4. The refrigerator of claim 1, wherein the controller is further configured to transmit state information about an operating state of the door to the external device through the communication interface while opening or closing the door according to the received setting information.

5. The refrigerator of claim 4, wherein the state information further includes at least one state among states including an opening state, an opening progress rate, a closing state, or a closing progress rate, and
the controller is configured to:
transmit at least one of the opening state or the opening progress rate to the external device through the communication interface while opening the door according to the received setting information, and
transmit at least one of the closing state or the closing progress rate to the external device through the communication interface while closing the door according to the received setting information.

6. The refrigerator of claim 1, wherein the controller is configured to transmit abnormal operation information about an abnormal operation of the door to the external device through the communication interface, based on identifying the abnormal operation of the door while opening or closing the door according to the received setting information.

7. The refrigerator of claim 6, wherein the abnormal operation information further includes at least one of an abnormal opening or an abnormal closing, and
the controller is configured to:
transmit the abnormal opening to the external device through the communication interface, based on identifying the abnormal opening while opening the door according to the received setting information, and
transmit the abnormal closing to the external device through the communication interface, based on identifying the abnormal closing while closing the door according to the received setting information.

8. The refrigerator of claim 7, wherein:
the door driving device comprises a motor, a door pusher configured to move to open the door by the motor, and a door link configured to move to close the door by the motor,
the refrigerator further comprises:
a torque sensor configured to detect a torque of the motor, and
the controller is configured to:
identify the abnormal opening of the door based on a motor torque detected by the torque sensor being greater than or equal to a preset value while opening the door according to the received setting information, and
identify the abnormal closing of the door based on a motor torque detected by the torque sensor being greater than or equal to the preset value while closing the door according to the received setting information.

9. The refrigerator of claim 6, wherein the controller is configured to control the door driving device to stop the door, based on identifying the abnormal operation of the door while opening or closing the door according to the received setting information.

10. The refrigerator of claim 1, wherein the controller is configured to:
determine that the opening condition is satisfied, based on a condition in which a touch operation for opening the door is detected through a touch sensor on the door, a condition in which a user command for opening the door is received through a control panel, or a condition in which a door opening command for opening the door is received from the external device through the communication interface being satisfied, and
determine that the closing condition is satisfied, based on a condition in which a touch operation for closing the door is detected through the touch sensor on the door, a condition in which a user command for closing the door is received through the control panel, or a condition in which a door closing command for closing the door is received from the external device through the communication interface being satisfied.

11. A method of controlling a refrigerator, comprising:
executing by a controller of the refrigerator a process configured by the controller that includes,
receiving setting information including at least one received setting information item among setting information items to set an opening speed of a door of the refrigerator, a closing speed of the door, an opening time delay of the door from a time point at which an opening condition is satisfied, or a closing time delay of the door from a time point at which a closing condition is satisfied; and
opening or closing the door, based on the opening condition or the closing condition being satisfied, and according to the at least one received setting information item among the setting information items.

12. The method of claim 11, wherein the received setting information is provided from a setting screen of a user interface for setting the received setting information through a smart appliance application installed on a user device, the setting screen including at least one setting of the opening speed of the door information item or the closing speed of the door information item.

13. The method of claim 12, wherein the setting screen further includes at least one setting of the opening time delay item or the closing time delay item.

14. The method of claim 12, wherein the received setting information further includes a setting of a volume of an alarm sound, and
the setting screen further includes the volume of the alarm sound information item.

15. The method of claim 11, wherein the opening or closing of the door comprises:
determining that the opening condition is satisfied, based on a condition in which a touch operation for opening the door is detected through a touch sensor on the door, a condition in which a user command for opening the door is received through a control panel, or a condition in which a door opening command for opening the door is received from a server through a communication interface being satisfied, or
determining that the closing condition is satisfied, based on a condition in which a touch operation for closing the door is detected through the touch sensor on the door, a condition in which a user command for closing the door is received through the control panel, or a condition in which a door closing command for closing the door is received from a server through the communication interface being satisfied.
